(19) United States
(12) Patent Application Publication
(10) Pub. No.: US 2008/0290007 A1
(43) Pub. Date: Nov. 27, 2008

(54) CENTRIFUGAL LENGTH SEPARATION OF CARBON NANOTUBES

(75) Inventors: Jeffrey Alan Fagan, Bethesda, MD (US); Matthew Becker, Frederick, MD (US)

Correspondence Address: RANKIN, HILL & CLARK LLP, 38210 Glenn Avenue, WILLOUGHBY, OH, 44094-7808, US

(73) Assignee: NATIONAL INSTITUTE OF STANDARDS AND TECHNOLOGY, Gaithersburg, MD (US)

(21) Appl. No.: 12/122,288

(22) Filed: May 16, 2008

Related U.S. Application Data
(60) Provisional application No. 60/939,915, filed on May 24, 2007.

(51) Int. Cl. B07C 5/12

(52) U.S. Cl. 209/659

(57) ABSTRACT

Processes for separating carbon nanotubes according to their length are described. The processes involve forming highly dispersed systems of the nanotubes followed by creating an array of layers in a centrifugation vessel. Each layer contains dispersed nanotubes with varying proportions of a density adjusting agent. The vessel array includes a first layer containing the nanotubes to be separated, and one or more layers of lesser density disposed above the first layer. Upon centrifuging for a sufficient period of time, a series of liquid fractions form in the vessel. The average length of nanotubes in a respective fraction is different than the average length of nanotubes in the other fractions.

### CROSS REFERENCES TO RELATED APPLICATION

The present application claims priority from U.S. provisional patent application Ser. No. 60/939,915 filed May 24, 2007.

### FIELD OF INVENTION

The presently disclosed embodiments are directed to the field of carbon nanotubes, and particularly to methods for separating carbon nanotubes and isolating particular populations of carbon nanotubes.

### BACKGROUND OF THE INVENTION

Scalable nano-manufacturing of single wall carbon nanotube (herein periodically referred to as “SWCNT”) devices, sensors, and therapeutic agents require precursors that exhibit well-defined length, chirality, and dispersion characteristics. However, existing synthetic and dispersion methods for SWCNTs produce heterogeneous mixtures of tube diameters, lengths and chiralities. As the unique optical, physical, thermal and electronic properties of SWCNTs arise from the specific chiral wrapping vector of the graphene sheet, the necessity for separation of SWCNT materials by chirality is readily appreciated. However, the strength and usability of chirality specific properties also depends strongly on the length of the nanotube, and thus length fractionation is also desirable or required for many applications. The cost-effectiveness of performing both of these separations will determine the future utility of technologies based upon SWCNTs.

The economical separation of SWCNTs by length and wrapping vector is an area of substantial ongoing research. Length separation has been carried out using various chromatographic techniques, including gel electrophoresis and size exclusion chromatography (SEC), which yield populations possessing well-defined lengths and length distributions. For example, U.S. Pat. No. 7,131,537 describes methods for separating nanotubes by size. The separation methods produce fractions of nanotubes with different lengths. However, the separation methods are all chromatography based. The patent indicates that gel permeation chromatography is preferred, see col 4, lines 1-3.

While SEC methods are scalable in principle, lengths have been limited in practice by the exclusion limit of the column stationary phase, which is generally less than 600 nm. Accordingly, it would be desirable to separate and isolate populations of SWCNTs by length, using techniques that were not limited to such relatively small lengths and which enabled separation and isolation of populations having significantly greater lengths.

Since the development of high speed ultracentrifugation in the early twentieth century, the separation of solutes with weak buoyancy differences has been feasible due to the enormous centripetal acceleration generated by such instruments. Separations by centrifugation to obtain nanotubes have been described by various artisans, such as in the following patents. U.S. Pat. No. 5,560,898 discloses a process of isolating carbon nanotubes from a mixture of nanotubes and graphite particles, by centrifuging a dispersion of the material in a liquid medium. After centrifuging, the nanotubes are left in the liquid medium, while the graphite particles are in a precipitate. However, the nanotubes are not further separated in any manner. U.S. Pat. No. 7,029,645 describes a method for “cleaning” a carbon nanotube sample by dispersing it in an organic solvent, and then centrifuging to separate the nanotubes from the impurities. However, the collected “cleaned” nanotubes are not further separated by size or any other characteristic.

The use of ultracentrifugation on SWCNTs within a density gradient to produce a more facile and scalable chirality separation was described by Arnold et al., in “Sorting Carbon Nanotubes by Electronic Structure Using Density Differentiation,” Nature Nanotech, 1, 60-65 (2006) (herein referred to as “Arnold et al.”). This work is based upon driving the SWCNTs to their individual equilibrium locations within the density gradient. That is, Arnold et al. demonstrated the use of ultracentrifugation to produce chirality separation of different diameter nanotubes by driving the position of the SWCNTs to their different isopycnic (equilibrium buoyancy) locations within a density gradient. However, Arnold et al. did not provide any strategies for separation of SWCNTs according to their length.

Recently, several methods have been described to enhance SWCNT population purity of individual SWCNT species. These methods include electrophoresis, dielectrophoresis, and ion exchange chromatography, which have all been demonstrated to separate tubes by diameter and electronic structure, although with limited throughput. Although satisfactory in certain respects, a need remains for a commercially scalable process for purifying one or more SWCNT species. It would also be beneficial to provide such processes that were economical. And, as will be appreciated, it would be particularly desirable to provide a method for large scale and economical separations of these species by length.

Increasingly, efforts at separation are incorporated with purification efforts, for the removal of non-SWCNT carbon and metallic residues, and the individualization of the nanotubes via surfactant dispersion. Surfactant dispersion, whether using small molecule surfactants such as sodium dodecyl sulfate (SDS), sodium dodecyl-benzyl sulfate (NaDDBS), biological molecules such as DNA, or bile salts such as either sodium cholate (NaChol) or sodium deoxycholate (DOC) typically involves two steps, sonication of the SWCNTs in the presence of the surfactant, and centrifugation to remove the less buoyant material, including much of the catalyst and amorphous carbon impurities. Again, although satisfactory in certain aspects, a need remains for a strategy by which SWCNTs can be readily separated, purified, and isolated. And, it would be particularly desirable to provide techniques for such operations that could be readily performed at a commercial scale where economics and high throughput are primary objectives.

### SUMMARY OF THE INVENTION

The difficulties and drawbacks associated with previous methods and associated systems are overcome in the present method and system for a strategy by which carbon nanotubes can be separated by length.

In a first aspect, the present invention provides a method for separating carbon nanotubes by length. The method comprises providing carbon nanotubes having different lengths and dispersing the nanotubes in a suitable medium to solubilize the nanotubes and thereby form a first liquid. The method further comprises preparing a second liquid having an appropriate density with respect to the solubilized nanotubes. The method also comprises forming an array of liquid layers in a vessel including a first layer comprising the first liquid and a second layer disposed above the first layer, the second layer comprising the second liquid. And, the method comprises centrifuging the vessel and array of layers for a time period sufficient for at least a portion of the nanotubes in the first layer to migrate into the second layer and form a plurality of fractions in the second layer, wherein each fraction includes carbon nanotubes having an average length different than that of other fractions in the vessel.

In another aspect, the present invention provides a method for separating carbon nanotubes by length. The method comprises obtaining carbon nanotubes having a range of different lengths. The method also comprises dispersing the carbon nanotubes in a first liquid to thereby form a dispersed sample of carbon nanotubes. The method further comprises selecting a second liquid having a density such that the difference between (i) the density of the second liquid and (ii) the average density of the carbon nanotubes in the dispersed sample, is greater than the difference between (ii) and (iii) the density of any species of carbon nanotubes in the dispersed sample. The method further comprises in a vessel adapted for centrifugation, forming a first layer comprising at least a portion of the dispersed sample and forming a second layer comprising at least a portion of the second liquid, wherein the second layer is disposed above the first layer. And, the method comprises centrifuging the vessel and first and second layers for a time period sufficient for a plurality of fractions to form within the second layer, wherein each fraction includes carbon nanotubes having an average length different than that of other fractions in the vessel.

In yet another aspect, the present invention provides a method for separating carbon nanotubes by length. The method comprises providing carbon nanotubes having different lengths and dispersing the carbon nanotubes in water to form an aqueous mixture of the nanotubes and water. The method also comprises forming a liquid having a density such that the difference between (i) the density of the liquid and (ii) the average density of the carbon nanotubes in the aqueous mixture, is greater than the difference between (ii) and (iii) the density of any species of carbon nanotubes in the aqueous mixture. The method further comprises forming an array of layers in a vessel including a first layer comprising at least a portion of the aqueous mixture; a second layer disposed above the first layer, the second layer comprising at least a portion of the liquid and having a density less than that of the first layer; and a third layer disposed below the first layer, the third layer having a density greater than that of the first layer. The method additionally comprises centrifuging the vessel and first, second, and third layers for a time period sufficient for a plurality of fractions to form within the second layer, wherein each fraction includes carbon nanotubes having an average length different than that of other fractions in the vessel.

As will be realized, the invention is capable of other and different embodiments and its several details are capable of modifications in various respects, all without departing from the invention. Accordingly, the drawings and description are to be regarded as illustrative and not restrictive.

### BRIEF DESCRIPTION OF THE DRAWINGS

FIG. 1 is a schematic illustration of a vessel containing a preferred embodiment layered array that includes a layer of carbon nanotubes to be separated by length.

FIG. 2 is a schematic flowchart depicting a preferred embodiment process for separating a population of carbon nanotubes by length.

FIG. 3 includes a schematic diagram, photographs, and related graphs of the initial and final location of carbon nanotubes, and UV-vis-NIR spectra for various indicated fractionation locations associated with a preferred embodiment process of the present invention.

FIG. 4 is a graph illustrating apparent length versus fraction number at 4 hours, 9 hours and 19 hours of centrifugation in accordance with a preferred embodiment process.

FIG. 5 shows the spectra of various separated carbon nanotubes.

FIG. 6 is a graph of theoretical nanotube displacement calculated as a function of the nanotube length.

FIG. 7 includes schematic illustrations and photographs of a preferred embodiment length separation by centrifugation process for carbon nanotubes.

FIG. 8 is a graph of carbon nanotube length for various fractions.

FIG. 9 is a collection of images for two fractions after a preferred embodiment separation process.

FIG. 10A is a graph of absorbance and wavelength for various fractions after a preferred embodiment separation process.

FIG. 10B is a contour plot of emission energy and excitation wavelength.

FIG. 10C is a contour plot of emission energy and excitation wavelength.

FIG. 11 is a graph of Raman scattering of a fraction of collected nanotubes.

FIG. 12 is a graph of absorbance and wavelength for certain fractions.

FIG. 13 are photographs of various SWCNTs in vials prior to undergoing a preferred embodiment separation process.

FIG. 14A are photographs of various samples after a preferred embodiment separation.

FIG. 14B is a graph of projected length and distance traveled of carbon nanotubes subjected to various centrifugation speeds.

FIG. 15 is a graph of projected length of carbon nanotubes per fraction number.

FIG. 16 are photographs of various samples and a corresponding graph of projected length and fraction number associated with certain carbon nanotubes described herein.

FIG. 17 are photographs of samples and a corresponding graph of length and fraction number associated with separating carbon nanotubes at different temperatures.

FIG. 18 is a graph of projected length and distance traveled of carbon nanotubes centrifuged at various rotational speeds.

FIG. 19 is a graph of length and distance traveled for certain carbon nanotubes.

FIG. 20 is a graph illustrating redistribution of a density adjusting agent during centrifugation.

### DETAILED DESCRIPTION OF THE EMBODIMENTS

The present invention is based upon a discovery that the transient, i.e. rate dependent, motion of carbon nanotubes, and preferably SWCNTs, in response to an applied centripetal acceleration field can be utilized to achieve length separation. That is, carbon nanotubes can be separated according to their length by use of the particular strategies described herein. Specifically, for nanotubes of different aspect ratio but having the same diameter, the velocities of the nanotubes scale approximately with the natural logarithm of the aspect ratio, which allows for sufficient separation in a process that allows for fractionation.

The preferred embodiment methods according to the present invention generally involve first forming a dispersion or solution of the population of carbon nanotubes to be separated. After suitably dispersing the nanotubes, an agent having particular density characteristics relative to the dispersed nanotubes is selected. Using that selected agent, an array of liquid layers is then formed in a suitable vessel. The selected agent is periodically referred to herein as a “density adjusting” agent. Generally, a first layer of the dispersed nanotubes to be separated by length, is formed in the vessel. This first layer is periodically referred to herein as an “injection” layer. Next, one or more liquid layers having densities less than that of the injection layer are then formed above the injection layer. The one or more lighter density layers comprises the selected agent having the desired density characteristics and varying amounts of one or more liquids. The proportions of the density adjusting agent and the one or more liquids are selected so as to achieve a desired density for the particular layer. The one or more liquids preferably exhibit densities less than that of the density adjusting agent. It is also contemplated that an optional upper layer may be formed comprising the one or more liquids and which is free of the density adjusting agent. All of the layers between the first (or injection) layer and the upper layer are generally referred to herein as “race layers,” since those are the layers through which the dispersed nanotubes migrate during a centrifugation operation. The layered array may also include one or more relatively dense layers under the injection layer. These underlayers preferably comprise relatively high concentrations of the density adjusting agent and lesser amounts of the one or more liquids used in the race layers. After formation of the layered array in the vessel, the vessel and its contents are subjected to a centrifugation operation. Centrifugation is performed for a period of time sufficient to allow two or more fractions to form in the race layers. Each resulting fraction contains carbon nanotubes having an average length that is different than the average lengths of carbon nanotubes contained in other fractions in the race layers. As explained herein, generally, carbon nanotubes having longer lengths are present in upper residing fractions, while shorter length carbon nanotubes are present in fractions closer to the first layer.

Each of these aspects and operations are now described in greater detail. After obtaining a collection or sample of carbon nanotubes which are to be separated by length, the collection of nanotubes is dispersed in a liquid such that ideally all of the carbon nanotubes are individually dispersed in the liquid. The liquid may be water or any other vehicle so long as the nanotubes can be sufficiently solubilized so that they are not in a bundled or otherwise agglomerated state. One or more surfactants and/or other additives may be used to promote such dispersion of the carbon nanotubes.

Dispersion of the carbon nanotubes in a liquid can be greatly facilitated by subjecting the nanotubes in liquid to sonication for a sufficient period of time so that all, or at least a relatively high proportion of the carbon nanotubes are individually dispersed in the liquid. After sonication, it is preferred to remove carbonaceous and metallic impurities. This can be readily performed by subjecting the sonicated sample to a centrifugation operation that pellets these impurities. The supernatant primarily contains individually dispersed carbon nanotubes.

Next, one or more density adjusted liquids for use as the race layers are prepared or otherwise obtained. As previously explained, the race layers are deposited above the layer containing the sample of carbon nanotubes to be separated, i.e. the injection layer. The race layers comprise a particular agent, which may be a liquid, generally referred to herein as a density adjusting agent having certain density characteristics relative to the dispersed nanotubes. Generally, the race layers comprise varying proportions of the density adjusting agent and one or more liquids selected so as to achieve a desired density for the particular race layer. The race layers may also comprise amounts of other additives described in greater detail herein. The number of race layers may vary depending upon the particular application and degree of separation desired, among a host of other factors. However, for many applications it is sufficient that a single race layer be used.

After formation of the various density adjusted liquids, an array of layers is formed or otherwise deposited in a suitable vessel. The vessel can be nearly any type of vessel appropriate for centrifugation. Preferably, one or more relatively dense underlayers are deposited in the vessel. The underlayers can be formed from liquids comprising a relatively high concentration of the density adjusting agent. On top of these, an injection layer containing a relatively high proportion of carbon nanotubes to be separated is then deposited. Next, the race layers are deposited on the injection layer. For example, for a layered array having three race layers, a vessel containing an injection layer and an optional underlayer is provided. A first race layer having a density less than that of the injection layer but greater than the densities of the other two race layers is deposited in the vessel on the injection layer. This first race layer comprises an amount of the density adjusting agent and another liquid. A second race layer is deposited in the vessel on the first race layer, and also comprises an amount of the density adjusting agent and the other liquid. The proportions of these components are selected so that the second race layer has a density less than that of the first race layer. A third race layer is deposited on the second race layer. The third race layer comprises an amount of the density adjusting agent and the other liquid. The proportions of these components are selected so that the third race layer has a density less than that of the second race layer. An optional upper layer may be deposited on the uppermost, e.g. third, race layer. It will be appreciated that the present invention includes layered arrays having a different number of race layers, such as one, two, or more than three race layers. These aspects are described in greater detail herein.

The vessel containing the resulting array of layers is then subjected to a centrifugation operation. Preferably centrifugation is performed for a period of time sufficient for the carbon nanotubes in the injection layer to migrate into the race layers, and thus form the noted fractions containing various populations of the nanotubes differing by length.

As noted, one or more surfactants can be used to assist in the dispersion of the nanotubes. Also, one or more surfactants can be used in the preparation of the density adjusted race layers. A surfactant is not intrinsically necessary to the separation process, but in practice is preferred to achieve robust individualization of the SWCNTs. Sodium deoxycholate is most preferred since it is relatively inexpensive, and it maintains continuous, complete, individualization of the nanotubes under the conditions of the separation. Other surfactants, such as DNA, cost significantly more to achieve the same result, or cannot completely maintain individualization of the dispersed nanotubes in solution at any sort of meaningful concentration. In general, any surfactant can be used if it is used under conditions at which it maintains (complete or acceptably complete) individualization of the SWCNTs, makes them primarily non-interacting, and maintains a density that is primarily concentration independent. Most preferably, DNA and sodium deoxycholate have been demonstrated to meet these requirements, particularly at moderate and high concentrations of SWCNTs.

A wide array of surfactants, dispersal agents, and other additives can likely be used in the processes of the present invention. For example, it is contemplated that many of the systems and surfactants known in the art may be suitable. For example, the surfactants and systems disclosed in U.S. Pat. No. 7,074,310 may be suitable. In addition, the dispersal agents, emulsifying agents, detergents, surfactants, and other additives disclosed in U.S. Pat. No. 7,166,266 may be appropriate for use in the present invention methods.

Also, as noted, one or more density adjusting agents are used to form at least some of the various layers in the layered array. Preferably, the liquid or density adjusting agent is iodixanol, which is commercially available in an aqueous solution under the designation Opti-prep™, available from Sigma Chemical. Iodixanol is 5,5′-[(2-hydroxy-1-3 propanediyl)-bis(acetylamino)]bis [N,N′-bis(2,3dihydroxylpropyl-2,4,6-triiodo-1,3-benzenecarboxamide]. Opti-prep™ is a 60% (w/v) solution of iodixanol in water.

As noted, the density adjusting agent Opti-prep™ is actually an aqueous solution of polymer in water. There is no intrinsic restriction against the use of other dense liquids, aqueous or non-aqueous, as long as several parameters are met. The SWCNTs must be dispersed as individual tubes, and ideally as non-interacting individuals. They must be stable in the solution (non-aggregating). The medium must maintain enough density under centrifugation to allow sufficient time for the separation. The nanotubes must be able to move or translate in the manner dictated by the free particle hydrodynamics (i.e. no gels, as this would change the hydrodynamic scaling). And other non-ideal effects (such as sedimentation potentials and other charging effects) should be minimized.

To generate length, rather than chirality separation, the race layer(s) must also be dense enough such that the difference in density of different types of nanotubes is relatively small as compared to the difference in densities between the nanotubes (as dispersed) and the bulk liquid. The effective density of the SWCNTs varies in different solutions based upon how the nanotubes have been dispersed, so the absolute required density of the liquid can only be truly set once the dispersion protocol is known.

A wide variety of other aqueous density media are commercially available. Accordingly, it is contemplated that other media may be useable. The key is to meet the previously noted preferences. As for non-aqueous solutions, there are no intrinsic reasons why the separation would not work, so long as the previously noted preferences were met.

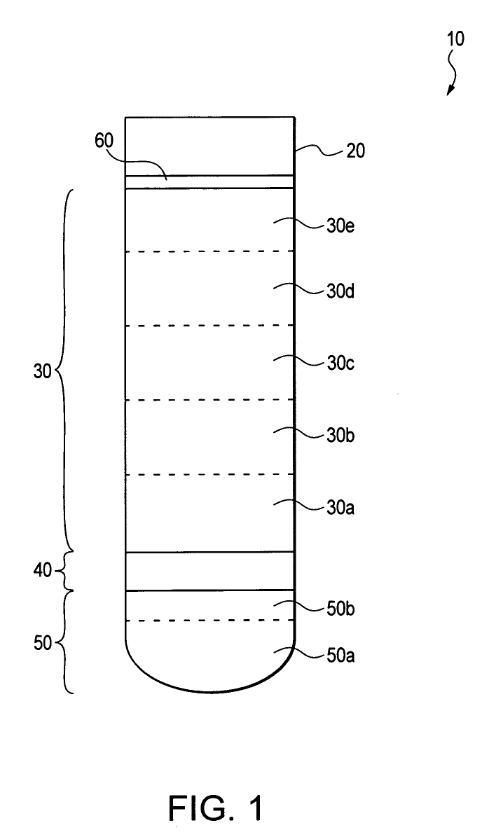

Referring to FIG. 1, a schematic illustration of a preferred embodiment array 10 of layers in a vessel 20 is shown. Specifically, the vessel 20 contains one or more underlayers 50 such as a first underlayer 50a and a second underlayer 50b. The vessel 20 also contains an injection layer 40. And, the vessel contains one or more race layers 30 such as a first race layer 30a, a second race layer 30b, a third race layer 30c, a fourth race layer 30d, and a fifth race layer 30e. Although multiple race layers are noted, it is preferred for most applications that a single race layer be used. An optional upper layer 60 may also be utilized. It will be appreciated that the present invention includes arrays having a greater or lesser number of layers than that depicted in FIG. 1. In addition, it is to be understood that the present invention includes a collection of race layers 30 and underlayers 50 having a greater or lesser number of layers than shown in FIG. 1. Preferably, the present invention layered array includes a total of four layers—two underlayers, a single injection layer, and a single race layer.

The injection layer comprises solubilized and preferably, individually dispersed SWCNTs in a medium. Preferably, the SWCNTs are in a medium of iodixanol and water. A representative composition of the medium in the injection layer, using iodixanol is from about 18% to about 22% iodixanol, and about 2% surfactant, and the remainder portion being water.

As noted, in many applications, it is preferred to use a single race layer. Using iodixanol as the density adjusting agent, typical compositions of the race layer include for example, from about 15% to about 30% iodixanol, from about 0.5% to about 4% surfactant, and from about 65% to about 85% water. Preferably, the concentration of iodixanol in the race layer(s) is from about 15% to about 25%. The concentration of surfactant in the race layer(s) is preferably about 2%. Water is preferably present in a majority proportion in the race layer(s). It will be appreciated that the present invention includes the use of these components in different proportions and in combination with additional or different components. Moreover, as previously noted, the present invention is not limited to the use of iodixanol as the density adjusting agent.

The underlayer(s) typically comprise amounts of the density adjusting agent used in the race layer(s), surfactant, and water. For systems using iodixanol, the concentration of iodixanol in the underlayer(s) typically ranges from about 30% to about 50% with a preferred concentration of 30% to 40%. Surfactant may also be included in the underlayer(s) in an amount of from about 0.5% to about 4%, and preferably 2%. The underlayer(s) preferably comprise water in remainder amounts.

The volume amounts of each respective layer type may be expressed relative to the amount of the injection layer. Preferably, the amount of the underlayer(s) is from about 50% to about 200% of the amount of the injection layer. And, the amount of the race layer(s) is preferably from about 100% and more preferably from about 500% to about 1000% of the amount of the injection layer. The race layer should be large enough such that an approximate uniform density is maintained despite the sedimentation of the iodixanol (or other density adjusting agent), and such that there is enough room for the SWCNTs to separate in position within the vessel or centrifuge tube. However, the present invention includes amounts for the underlayer(s) and the race layer(s) greater than or lesser than these indicated amounts. The amount of the upper layer is not critical, however is contemplated to typically be greater than the amount of the injection layer.

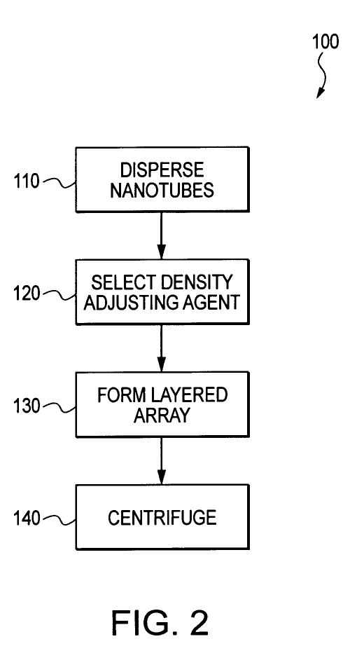

FIG. 2 is a preferred embodiment process 100 for separating a population of carbon nanotubes into various fractions of different lengths, in accordance with the present invention. In a first operation, the population of carbon nanotubes is dispersed in a liquid vehicle. That is, it is preferred to attain a state in which the various nanotubes are individually dispersed in the liquid vehicle so as to minimize any bundling or agglomerating of the nanotubes that may otherwise occur. This operation or series of operations is designated as 110 in FIG. 2. A preferred technique for attaining such highly dispersed state is to form an aqueous dispersion of the nanotubes by sonicating the liquid. One or more surfactants or other additives may be added to the liquid to promote solubilizing the nanotubes. After sufficient dispersion, impurities are then removed, such as by centrifuging.

Operation 120 in FIG. 2 illustrates selection of one or more suitable density adjusting agents for use in the length separation process described herein. Preferably, the density adjusting agent is used to form a liquid, i.e. the race layer, having a density such that the difference in the densities of the various length nanotubes to be separated is relatively small as compared to the difference between the average density of the dispersed nanotubes and the density of the race layer liquid. Specifically, in selecting a density adjusting agent, the agent is preferably selected and combined with one or more other liquids to form the race layer(s) such that the density of the race layer satisfies the following relationship. The density of the race layer liquid is preferably such that the difference between (i) the density of the race layer liquid and (ii) the average density of the carbon nanotubes in the dispersed sample is greater, and preferably significantly greater, than the difference between (ii) and (iii) the density of any species of carbon nanotubes in the dispersed sample. As explained herein, for length separation of SWCNTs in an aqueous dispersion, iodixanol has been found to be a preferred density adjusting agent. However, the present invention includes the use of other agents instead of or in combination with iodixanol.

FIG. 2 illustrates another set of operations collectively designated as 130 and which are directed to forming a layered array in a vessel, such as previously described array 10 and vessel 20 in FIG. 1. Preferably, a suitable vessel is obtained for subsequent receiving of the layered array. The vessel is preferably adapted for centrifugation and may be one specifically for use with the particular centrifuge used in operation 140 described below. The layered array is preferably formed by preparing one or more liquids for use as underlayer(s) in the vessel. These underlayers preferably comprise the density adjusting agent such as iodixanol and one or more other liquids such as water. The proportion of the density adjusting agent is selected such that the density of the underlayer is greater than that of the injection layer. For a process of length separation of SWCNTs in iodixanol and water, the underlayer preferably comprises at least 30% iodixanol. After formation of the liquid for use as the desired underlayer, the liquid is transferred into the vessel, such as by pipetting. After formation of the one or more underlayers, the injection layer containing the dispersed SWCNTs to be separated, is then deposited on the underlayer(s) in the vessel. After formation of the injection layer, the race layer is formed. As noted, the race layer comprises an amount of the density adjusting agent, such as iodixanol, and one or more additional liquids such as water. The proportion of the density adjusting agent, e.g. iodixanol, is selected so that the density of the race layer(s) is less than that of the injection layer. Preferably, for separating SWCNTs using iodixanol and water, the race layer typically comprises less than about 30% and preferably less than about 25% iodixanol. The liquid for use as the race layer is then transferred into the vessel and deposited on the injection layer to thereby form a race layer. An upper layer may optionally be formed on top of the race layer(s).

The preferred process 100 further comprises a centrifugation operation shown in FIG. 2 as operation 140. In this operation, the vessel containing the layered array is subjected to application of very large acceleration forces. Preferably, centrifugation is performed to create centrifugal speed forces of at least 10,000 g; preferably 25,000 g, and most preferably at least 40,000 g. Centrifugation is performed for a time period sufficient to enable a collection of fractions to form within the vessel. Typically, multiple layered fractions will form in the region of the vessel occupied by the race layer(s). As explained herein, the various respective fractions contain SWCNTs separated by length.

Various types of centrifuges can be used for operation 140, such as for example fixed angle centrifuges, swinging bucket centrifuges, vertical centrifuges, and depending upon the application, near vertical tube rotors.

Selection of a rotor depends on a variety of conditions, such as sample volume, number of sample components to be separated, particle size, desired run time, desired quality of separation, type of separation, and the centrifuge in use. Fixed angle rotors are general purpose rotors that are especially useful for pelleting particles and in short-column banding. Tubes are retained at an angle (usually 20 to 45 degrees) to the axis of rotation, typically in numbered tube cavities. The tube angle shortens the particle pathlength, compared to swinging bucket rotors, resulting in reduced run times.

Swinging bucket rotors allow tubes in swing outward. Gradients of all shapes and steepness can be used.

Vertical tube rotors hold tubes parallel to the axis of rotation; therefore, bands separate across the diameter of the tube rather than down the length of the tube.

Near vertical tube rotors are designed for gradient centrifugation when there are components in a sample mixture that do not participate in the gradient. The reduced tube angle of these rotors significantly reduces run times from the more conventional fixed angle rotors, while allowing components that do not band under separation conditions to either pellet to the bottom or float to the top of the tube.

Selection of a suitable vessel for centrifuging the layered array also depends upon numerous factors such as, but not limited to the centrifugation technique to be used, including the rotor in use, volume of sample to be centrifuged, need for sterilization, importance of band visibility, and so forth; chemical resistance—the nature of the sample and any solvent or gradient media; temperature and speed considerations; and whether tubes or bottles are to be reused.

Informative guides as to the selection and use of centrifuges, rotors, tubes and accessories are provided by Beckman Coulter, under the designations “Centrifuges, Rotors, Tubes & Accessories, Ultracentrifuges,” publication BR-8101L; and, “Rotors and Tubes, for Beckman Coulter Preparative Ultracentrifuges, User's Manual,” publication LR-IM-23.

Without wishing to be bound to any particular theory that may limit the present invention, the following is presented to more fully describe the behavior of populations of dispersed carbon nanotubes of varying lengths, and how they react when subjected to various forces that result in their separation by length.

For individually dispersed SWCNTs, differences in the scaling of the buoyancy and frictional forces allows for length separation of the nanotubes via a rate separation scheme. Discounting convection of the fluid, a Nernst-Planck formulation can be used to model the flux, Nᵢ, of each species i:

Nᵢ=cᵢF_{buoyancy}/fᵢ−Dᵢ∇cᵢ+U cᵢ (1)

Here, cᵢ is the concentration, fi is the friction factor and Dᵢ=k_{B}T/fᵢ the diffusion coefficient of species i; k_{B} is Boltzmann's constant, T is the temperature, and k_{B}T is the thermal energy of the solution. U is the velocity of bulk fluid convection, which is expected to be zero in the absence of instrumental artifacts such as vibration or thermal gradient driven mixing. The buoyant force, F_{buoyancy}, is:

F_{buoyancy}=π r² [symbol] *(ρₛ−ρ_{SWCNT,i})*Gᵢ (2)

in which r is the radius of the SWCNT plus the surfactant shell, [symbol] is the tube length, ρₛ and ρ_{SWCNT,i} are the density of the solution and the SWCNT (plus its surfactant shell) respectively, and G is the centripetal acceleration. Given average parameters for ultracentrifugation, |cᵢF_{buoyancy}/fᵢ|>>|Dᵢ∇cᵢ, and the diffusive flux can be eliminated from equation 1. The dependence of the friction factor suggests the possibility of length based separation. In the creeping flow limit, as indicated by a Reynolds number, Re=Vᵢρₛ [symbol] /η<<0.1, in which Vᵢ( [symbol] )=F_{buoyancy}/fᵢ is the ballistic velocity of an individual SWCNT, the friction factor for a long, thin rod the can be represented as

$${f}_{‖} = \frac{2 πη }{γ} ( \frac{1 + \frac{0.307}{γ}}{1 - \frac{0.5}{γ}} + \frac{0.426}{{γ}^{2}} ) , \\ {f}_{⊥} = \frac{4 πη }{γ} ( \frac{1 + \frac{0.307}{γ}}{1 + \frac{0.5}{γ}} + \frac{0.119}{{γ}^{2}} ) , \qquad ( 3 )$$

where η is the fluid viscosity and γ=ln(l/r). Combining equations 1 to 3 yields an equation for the flux in which the nonlinear dependence on SWCNT length, approximately proportional to ln(l/r), is clearly apparent.

$${N}_{i} ( ) \approx {c}_{i} \frac{( {ρ}_{s} - {ρ}_{SWCNT , i} ) {Gr}^{2}}{6 η} \frac{\begin{matrix}2 {γ}^{4} + 0.614 {γ}^{3} + \\ 0.544 {γ}^{2} - 0.136\end{matrix}}{\begin{matrix}{γ}^{3} + 0.614 {γ}^{2} + \\ 0.638 γ + 0.0135\end{matrix}} . \qquad ( 4 )$$

The consequence of the ln( [symbol] /r) dependence in equation (4) is that longer SWCNTs travel with a greater velocity in opposition to the applied acceleration.

Length separation, with minimal chirality differentiation, thus should occur in an experiment when Δρ=ρₛ− [symbol] ρ_{SWCNT} [symbol] >>Δρ_{SWCNT}= [symbol] ρ_{SWCNT} [symbol] −ρ_{SWCNT, i}, where ρ_{SWCNT, i} s the density of an individual SWCNT chirality, and [symbol] ρ_{SWCNT} [symbol] is the average density of all the SWCNT types in solution. Alternatively, chirality separation should be maximized when Δρ≈0 and different SWCNT types experience buoyancy forces in opposite directions.

Separation of single wall carbon nanotubes (SWCNTs) by length via centrifugation in a high density medium, and the characterization of both the separated fractions and the centrifugation process are further described herein. Significant quantities of separated SWCNTs ranging in average length from less than 50 nm to about 2 μm can be produced, with the distribution width being coupled to the rate of the separation. Less rapid separation is shown to produce narrower distributions. These length fractions, produced using sodium deoxycholate dispersed SWCNTs, were characterized by UV-Visible-near infrared absorption and fluorescence spectroscopy, dynamic light scattering, Raman scattering and atomic force microscopy. Several parameters of the separation were additionally explored: SWCNT concentration, added salt concentration, liquid density, rotor speed, surfactant concentration, and the processing temperature. The centrifugation technique is shown to support tens of milligrams per day scale processing and is applicable to all of the major SWCNT production methods: CoMoCat, HiPco, laser ablation, and electric arc. The cost per unit of the centrifugation based separation is also demonstrated to be significantly less than size exclusion chromatography based separations.

### Results of Testing

In a first set of trials, the following were investigated.

Materials: CoMoCat process SWCNTs were purchased from SouthWest Nanotechnologies (Norman, Okla.). Sodium deoxycholate and iodixanol were purchased from Fisher Scientific (Pittsburgh, Pa.) and Sigma-Aldrich (Milwaukee, Wis.) respectively, and used as received.

Ultracentrifugation: Controlled length fractionation was achieved for HiPco, laser and CoMoCat process SWCNTs via ultracentrifugation. SWCNTs were dispersed with 2% by mass sodium deoxycholate surfactant. SWCNT preparation consisted of sonication (tip sonicator, 0.32 cm, Thomas Scientific) of the SWCNT powder loaded at (1.0±0.2) mg/mL in the 2% surfactant solution in approximately 8.5 mL batches immersed in an ice water bath and tightly covered at 9 W of applied power for 2 h. Post-sonication, each suspension was centrifuged at 21,000 g in 1.5 mL centrifuge tubes for 2 h and the supernatant removed. The resulting rich black liquid contains primarily individually dispersed SWCNTs.

Density modified solutions were generated by mixing the appropriate surfactant or SWCNT solution with an iodixanol solution (OptiPrep, 60% mass by volume iodixanol) and 2% by mass sodium deoxycholate solution. Liquid layers were preformed by careful layering in 15 mL polycarbonate centrifuge tubes. A Beckman-Coulter J2-21 centrifuge with a JA-20 rotor was used. Suspensions were spun for 20 h at 20,000 rpm, generating an average force of 32,000 g with a maximum force of approximately 45,000 g. The individual fractions were collected by hand pipetting off each layer in 0.75 mL increments.

In determining the velocity of an individual SWNT, the velocity will be proportional to the difference in the specific density of each SWNT and the medium, according to:

Δρᵢ−(ρₛ−ρ_{SWCNT,i}). (5)

From the point at which the nanotubes stop being buoyant (known from experiment to be approximately 9% to 10% iodixanol for deoxycholate dispersion), ρ_{SWCNT} values covering the entire diameter distribution of CoMoCats are approximately 1053 to 1058 kg/m³. This value range matches the stated isopycnic density of (6,5) SWNTs in Crochet et al [J. Crochet, M. Clemens, T. Hertel, J. Am. Chem. Soc. 2007, 129(26), 8058.] and is consistent with the unstated ρ_{SWCNT} numbers of Arnold et al. In the reported experiments, the density of the liquid, ρₛ, was set to approximately 1137 kg/m³. Thus across the entire diameter range of CoMoCats, the maximum difference in ρ_{SWCNT} was about 5 kg/m³, compared to a Δρᵢ value of about 85 kg/m³. Thus any difference in velocity due to chirality effects was less than about 6%.

UV-Vis-NIR Spectrophotometry: UV-Vis-NIR was performed in transmission mode on a PerkinElmer Lambda 950 UV-Vis-NIR spectrophotometer over the range of 1350 to 350 nm. Measurements were typically performed on the extracted fractions in a 2 mm path length quartz cuvette. In all cases, the incident light was circularly polarized prior to the sample compartment, and the spectra corrected for both dark current and background. Data was recorded at 1 nm increments with an instrument integration time of at least 0.12 s per increment. The reference beam was left unobstructed, and the subtraction of the appropriate reference sample was performed during data reduction.

Atomic Force Microscopy: Tapping-mode atomic force microscopy (AFM) measurements were conducted in air using a Nanoscope IV system (Digital Instruments) operated under ambient conditions with 1-10 Ohm cm, phosphorous (n) doped silicon tips (Veeco; RTESP5, 125 μm length; 30 μM width, normal spring constant, 40 N/m; resonance frequency, 240 kHz to 300 kHz). Length separated surfactant-coated tubes were diluted 100× in water (18 MΩcm⁻¹) prior to being deposited (2 μL) onto plasma cleansed Si [1,1,1] wafers. After being allowed to dry, the entire sample was exposed to high intensity UV light for 2 h followed by 1 isopropanol and 3 water wash cycles using a solution deposition and wicking procedure to afford clear imaging conditions.

Under the centrifugation conditions described herein, nanotubes reached the top of the liquid column in less than 20 h, the time at which the solution volume was fractionated and the samples analyzed through ultraviolet-visible-near infrared spectroscopy (UV-Vis-NIR), dynamic light scattering (DLS), and atomic force microscopy (AFM). As in Arnold et al., iodixanol (5,5′-[(2-hydroxy-1-3 propanediyl)-bis(acetylamino)]bis [N,N′-bis(2,3dihydroxylpropyl-2,4,6-triiodo-1,3-benzenecarboxamide]), purchased as Opti-Prep™, was used to generate the various density solutions. In the experiment described herein, CoMoCat process SWCNTs were used, however the technique has been repeated with similar results using both laser and HiPco process SWCNTs.

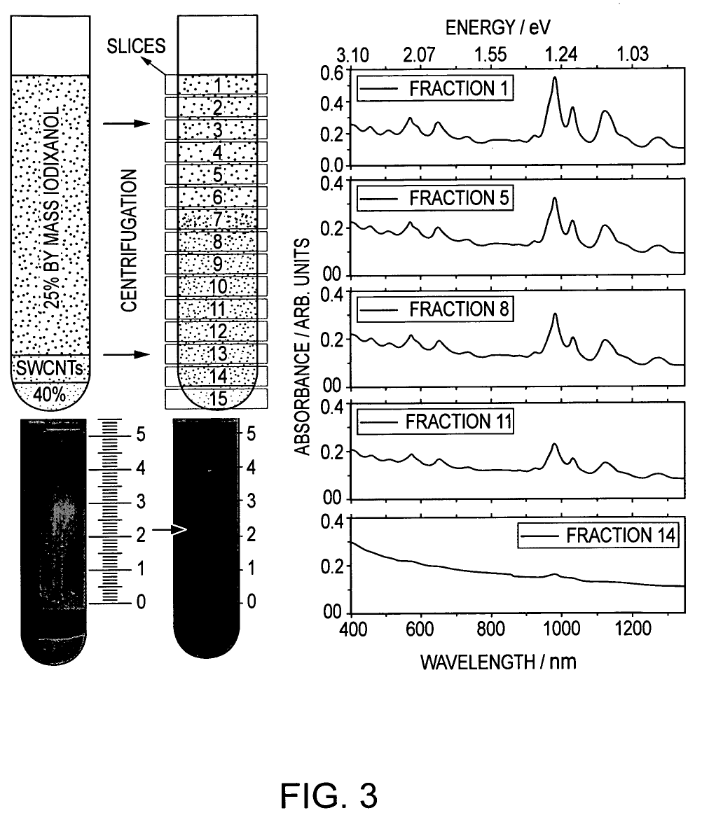

A schematic of aspects of a preferred embodiment process and specifically, spectra for several of the fractionated layers are shown in FIG. 3. When run to optimize the transient motion of the SWCNTs, spectra showing well-defined SWCNT peak features with increasing peak to baseline ratios are measured above the injection layer. No significant presence of SWCNT bundles, as would be observed by a combination of peak broadening and decrease in peak absorption relative to the baseline, was observed for deoxycholate dispersed SWCNTs. A small amount of high density impurities is seen to fractionate through the dense underlayer to the bottom of the tube. In sodium cholate dispersions, bundles are observed due to the significantly poorer stability of individual SWCNTs in sodium cholate solutions. In the deoxycholate results, no change in the chirality distribution with the length separation is measurable, as is evidenced by the constant relative sizes (to each other) of the chirality specific absorption features in FIG. 3.

Referring to FIG. 3, a diagram is shown of the initial and final location of the CoMoCat SWCNTs, and UV-vis-NIR spectra for the indicated fractionation locations. The SWCNTs were injected in a 30% iodixanol mass fraction layer. The longer fractions display sharp SWCNT optical transitions with no evidence of significant chirality selection. Fractions at and below the injection layer have features that are smeared and red-shifted. This sort of absorption feature is indicative of bundling. The absorbance spectra below 375 nm and above 1300 nm contain contributions from the iodixanol that are difficult to subtract. These contributions negligibly affect the spectra in the (400 to 1300) nm range.

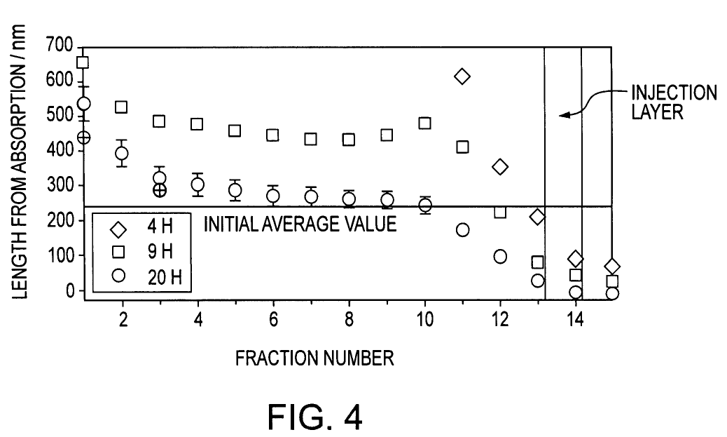

Lengths, shown in FIG. 4, are projected from the measured absorption ratio of the 984 nm peak to an approximate baseline value measured at 775 nm. The length dependence based on this ratio was calculated from a linear fit to the same ratio versus length measured for DNA-dispersed CoMoCat SWCNTs length separated by size exclusion chromatography. An approximate relation for the length for this batch of CoMoCat SWCNTS is:

$$( nm ) \approx ( \frac{Absorbance ( 984 nm )}{Absorbance ( 775 nm )} - 0.842 ) * 160.4 nm \qquad ( 6 )$$

Specifically, FIG. 4 illustrates apparent length versus fraction number at 4 h, 9 h and 19 h of centrifugation. The peak height to baseline ratio for the same SWCNT material wrapped with DNA and length separated by size exclusion chromatography was also used to project the length of the nanotubes. Each fraction was 0.45 cm tall. Error bars represent 10% of the projected length value due to uncertainty in the slope of equation (6). A change to this slope affects all projected values by a uniform multiplier. The crossed circles are AFM measured values for 20 h fractions. As overlapping tubes are not counted, AFM may underestimate the actual average length. Note that the concentration is not uniform across the fractions, and that the initial distribution of lengths is centered at approximately 215 nm.

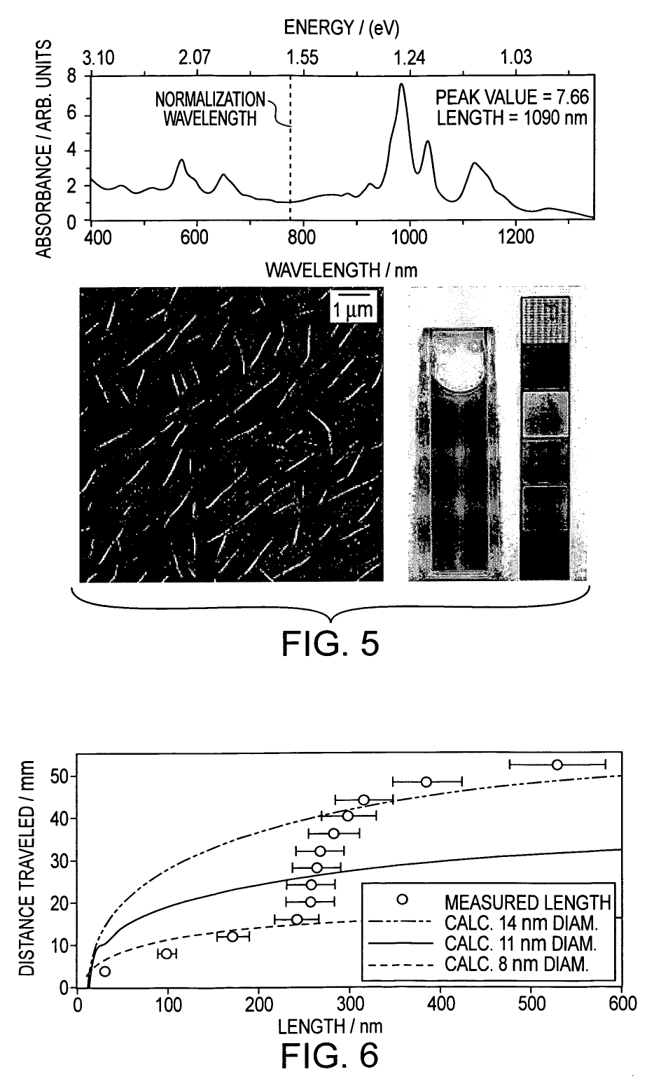

Values for the lengths measured using depolarized dynamic light scattering are in general agreement with the projected length values from the absorption. The large amount of iodixanol present in each fraction causes AFM measurement to be difficult. AFM measurements on the longest fraction isolated, and the corresponding absorption spectra (both shown in FIG. 5), yield lengths of (960±35) nm based on 175 SWNTs and 1093 nm respectively, indicating that length extrapolation using the UV-Vis-NIR absorption is sufficiently accurate. Of note is that the peak to baseline ratio shown in FIG. 5 is equivalent to the ratio calculable for the (6,5) purified samples shown in Arnold et al. Chirality purification of the sample shown in FIG. 5 would thus yield spectra with substantially larger peak to baseline values than previously demonstrated in a bulk sample. Error bars for lengths calculated by equation (5) are set to 10% of the average value, to project the estimated 10% uncertainty in the slope value.

Specifically, FIG. 5 shows the spectra of the longest separated material has a peak height to baseline ratio of approximately 7.6. This corresponds to a DNA-SWCNT calibrated length, via equation (6) of 1090 nm. The average length measured via AFM (amplitude image shown) for this fraction is 960 nm with a standard deviation of the mean (SDOM) of 35 nm, indicating that length separation is both occurring, and that the lengths can be sufficiently described by the DNA-SWCNT calibration. The small discrepancy in length for this specific fraction may be due to the small amount of chirality sorting apparent in the spectra, which would enhance the apparent optical length. The imaged fraction was collected from the top layer of the separation. This layer includes all lengths that have traveled that distance as the meniscus prevents the longest SWCNTs from traveling farther. This effect is the primary source of the polydispersity visible in the AFM. The photograph shows the color of the solution for the spectra shown.

FIG. 6 shows the SWCNT length versus distance traveled for the investigation detailed in FIG. 3. The lines are calculated length versus distance curves for the SWCNTs using equation (4). The measured velocity indicates an effective diameter of approximately 6 to 13 nm for the SWCNT plus its surfactant shell, assuming that the effective buoyancy difference, Δρ, is independent of the iodixanol concentration, and the equilibrium density value of 1055 kg/m³ is used for (ρ_{SWCNT}). Such a value for the effective diameter could indicate that either the effective buoyancy of the SWCNTs varies with the iodixanol concentration, or that the presence of the iodixanol molecules increases the length scale of the surfactant structure around each SWCNT. A combination of the two effects is also a possibility. This finding may indicate that the iodixanol molecule is functional in producing the buoyant density shell around the nanotube. An interesting effect notable in FIG. 6 is the sharp sigmoidal shape of the data. This effect is not noted for short time separations (as seen in FIG. 4), and is not captured by the first order theory given above.

Specifically, referring to FIG. 6, the theoretical SWCNT displacement calculated as a function of the nanotube length is illustrated assuming a value of 4, 5, or 6 nm for the effective radius and the following parameters: Δρ=83 kg/m³>>Δρ_{SWNT}, η=0.002 kg/ms, and G=40 000 g. Translational diffusion can be shown to be unimportant for this calculation. Error bars in length represent 10% of the of the projected length value due to uncertainty in the slope of equation (5). The uncertainty in the distance traveled is approximately equal to the point size. The curves likely do not overlap the data exactly due to unaccounted for phenomena, such as additional frictional drag from the sedimentation of the polymer, failure of the slender body approximation for shorter SWCNTs, possible relative alignment of longer SWCNTs due to motion or a sedimentation potential or surfactant driven effects (which could introduce a sigmoidal functionality to the theoretical curve), vibration driven mixing during the centrifugation, and the use of a non-optimal fixed angle rotor for the separation.

It is important to note that the length separation results presented here do not conflict with the results of Arnold et al. Given a proper density gradient above the injection layer, the separation will run to the point at which the tube densities approach the local density within the gradient. In this situation Δρ_{SWCNT}= [symbol] ρ_{SWCNT} [symbol] −ρ_{SWCNT,i} becomes important and the SWCNTs fractionate by chirality. For length separation, the key is to exploit the transient motion regime, not the regime in which buoyancy equilibrium is approached.

In summary, ultracentrifugation can be used to separate single wall carbon nanotubes by length. In this experiment, approximately 0.25 mg of dispersed CoMoCat SWCNTs were sorted by length in each of the identically prepared 15 mL centrifuge tubes, demonstrating that mg scale separation is easily obtainable. Additional investigations described below, explore a switch to a swinging bucket rotor to provide a theoretically optimal geometry for the separation, as well as additional parameters of the separation. As noted by Arnold et al., commercial centrifuges are available that can handle 0.5 L or more, while generating G>150 000 g, creating a strong potential for scale up.

In a second set of trials, the following were investigated.

Materials: Cobalt-molybdenum catalyst method (CoMoCat) (S-P95-02 Grade, Batch NI6-A001, Southwest nanotechnologies), SG grade CoMoCat (SG-000-0002, Southwest Nanotechnologies), high pressure carbon monoxide decomposition (HiPco) (Batch 286, Carbon Nanotechnologies Inc.), and laser ablation (NASA-JSC soot #338 and NanoPower Research Labs soot # NPRL-299) SWCNTs were dispersed in aqueous solution using 2% by mass sodium deoxycholate surfactant (Sigma). SWCNT preparation consisted of sonication (tip sonicator, 0.64 cm, Thomas Scientific) of the SWCNT powder loaded at (1.0±0.1) mg/mL in the 2% surfactant solution for 1.5 h in approximately 32 mL batches immersed in an ice water bath and tightly covered at approximately 30 W of applied power.

Post-sonication: Each suspension was centrifuged at 21,000 g in 1.5 mL centrifuge tubes for 2 hours, or 35,000 g for 2 h in 13 mL centrifuge tubes, and the supernatant collected. The resulting rich black liquid contains primarily individually dispersed SWCNTs.

Density modified solutions were generated by mixing the appropriate surfactant or SWCNT solution with iodixanol, (5,5′-[(2-hydroxy-1-3 propanediyl)-bis(acetylamino)]bis [N,N′-bis(2,3dihydroxylpropyl-2,4,6-triiodo-1,3-benzenecarboxamide]), purchased as Opti-Prep™ (Sigma)) and 2% by mass sodium deoxycholate solution; all percentages listed for iodixanol solutions are for percent mass. Appropriate dilutions were additionally made where specified. For the experiments, the density of the layers was chosen such that Δρ>>Δρ_{SWNT} in the starting layer and for 5 cm above. A dense underlayer was also included. These liquid layers were preformed by careful layering in either (17 or 38.5) mL centrifuge tubes (Beckman-Coulter #344061, #355631 respectively), with the center of the SWCNT layer defined as z=0.

Ultracentrifugation: A Beckman-Coulter L80-XP ultracentrifuge with a swinging bucket SW.32 Ti rotor was used with either the SW-32 or the SW-32.1 bucket sets, depending on the experiment, for the length separation and post-fractionation concentration of like fractions; a VTi.50 vertical rotor was additionally used for concentration of some fractions and further purification by diameter. In length separation experiments, the total volume separated was scaled with the inner diameter of the chosen centrifuge tube, such that for either SW-32 (38 mL) or SW-32.1 (17 mL) buckets, equivalent separation and fractions based on the distance traveled were achieved and collected. In the larger buckets, the typical preparation contained 24 mL of liquid in four layers: 1 mL of 40% iodixanol, 1 mL of 30% iodixanol, 2 mL of 20% iodixanol containing the SWCNTs, and 20 mL of 18% iodixanol in the top layer. All layers contained 2% sodium deoxycholate. After the separation, 16 (1.5 mL) individual fractions were collected in each case by hand pipetting from the top in 0.75 mL increments.

Concentration of like fractions was typically performed by uniform filling of the appropriate centrifuge tube with the length separated SWCNT solution, followed by ultracentrifugation. Under these conditions, the sedimentation of the iodixanol polymer gradually causes the SWCNTs to be excluded both from the bottom (as the polymer is more dense) and the top (as the SWCNTs are more dense than the surfactant alone) of the tube. Dilution of the top one-half to two-thirds of the individual length fraction with additional stock surfactant solution, to lower the average density in the top part of the tube, dramatically speeds this process. Some of these concentrated fractions were then additionally processed by dialysis against 0.8% DOC solution in 25 k MWCO dialysis floats to remove the remaining iodixanol and to reduce the total surfactant concentration.

Ultraviolet-visible-near infrared (UV-Vis-NIR) absorbance spectroscopy was performed in transmission mode on a Perkin Elmer Lambda 950 UV-Vis-NIR spectrophotometer over the range of (2500 to 185) nm for SWCNT-surfactant solutions, and from (1450 to 325) nm for SWCNT-surfactant-iodixanol solutions. Measurements were typically performed on the extracted fractions in a 2 mm path length quartz cuvette. In all cases, the incident light was circularly polarized prior to the sample compartment, and the spectra corrected for both dark current and background. Data was recorded at 1 nm increments with an instrument integration time of at least 0.12 s per increment. The reference beam was left unobstructed, and the subtraction of the appropriate reference sample was performed during data reduction.

Dynamic light scattering (DLS) was performed in a temperature controlled cell maintained at 25° C. using a Brookhaven Instruments BI-200SM in VH (crossed polarizers) configuration with 532 nm excitation. Scattering was measured at a minimum of three different angles with a minimum of two repetitions. Dialyzed samples were typically used for these measurements. The correlation of scattering intensity in each case was fit to a double exponential, and the resultant inverse rotational relaxation time is related to the squared magnitude of the scattering vector and the rotational diffusion coefficient in accordance with formalism of Pecora. SWCNT length was obtained from Dᵣ.

Tapping-mode atomic force microscopy (AFM) measurements were conducted in air using a Nanoscope IV system (Digital Instruments) operated under ambient conditions with 1 to 10 Ohm/cm, phosphorous (n) doped silicon tips (Veeco; RTESP5, 125 μm length; 30 μm width, normal spring constant, 40 N/m; resonance frequency, 240 kHz to 300 kHz). Length separated, concentrated and dialyzed fractions were diluted 10× in water (18 MΩcm-1) prior to being deposited (2 μL) onto plasma cleansed Si [1,1,1] wafers. After being allowed to dry, the entire sample was cleaned of surfactant with an ethyl acetate wash and wicking procedure to afford clear imaging conditions.

Raman spectra were collected in a collinear backscattering configuration. An Ar+ laser (Coherent Innova Sabre with multi-line visible head) provided the excitation; approximately 20 mW of power was focused to a spot size of approximately 100 μm within the sample volume. Samples were measured in a single semi-micro spectrophotometer cell (NSG, 10 mm path length) that was held immobile for all of the measurements. The spontaneous Raman backscattered light was collected with a triple grating spectrometer (Dilor XY800) and a liquid nitrogen cooled CCD detector. The signal was integrated for an appropriate time to obtain a signal to noise ratio greater than 50. The integration time for the CoMoCat fractions shown here was 10 s averaged over four scans. Data were collected with excitation at 514.5 nm. At the 514.5 nm excitation line Raman frequency shifts in the range (150 to 4000) cm⁻¹ were measured, with specific attention given to those between (150 and 2800) cm⁻¹. Data were corrected solely by scaling for incident laser intensity and by the subtraction of a small background, generally less than a few percent of the feature intensity.

Visible and NIR fluorescence were recorded using a Horiba Jobin Yvon nanolog-3 spectrofluorometer with a liquid N₂-cooled InGaAs detector. Emission spectra were corrected for the instrument's source spectral distribution, detector spectral response, and for the absorbance of the filter used to restrict scattered excitation light from the NIR monochromotors and detector. Excitation wavelength were scanned in 5 nm increments unless otherwise noted using a 450 W xenon lamp through an 8 nm slit and emission collected at 90° in either 1, 2 or 4 nm increments through an 8 nm slit. To account for differences in concentration, fractions were diluted to a common absorbance of 0.05 per cm at 775 nm, and were measured in a 10 mm square quartz cuvette.

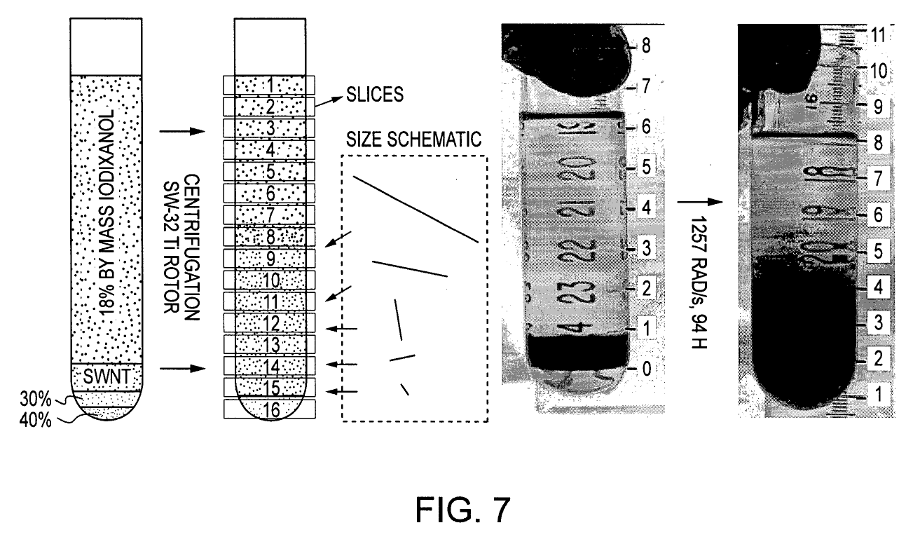

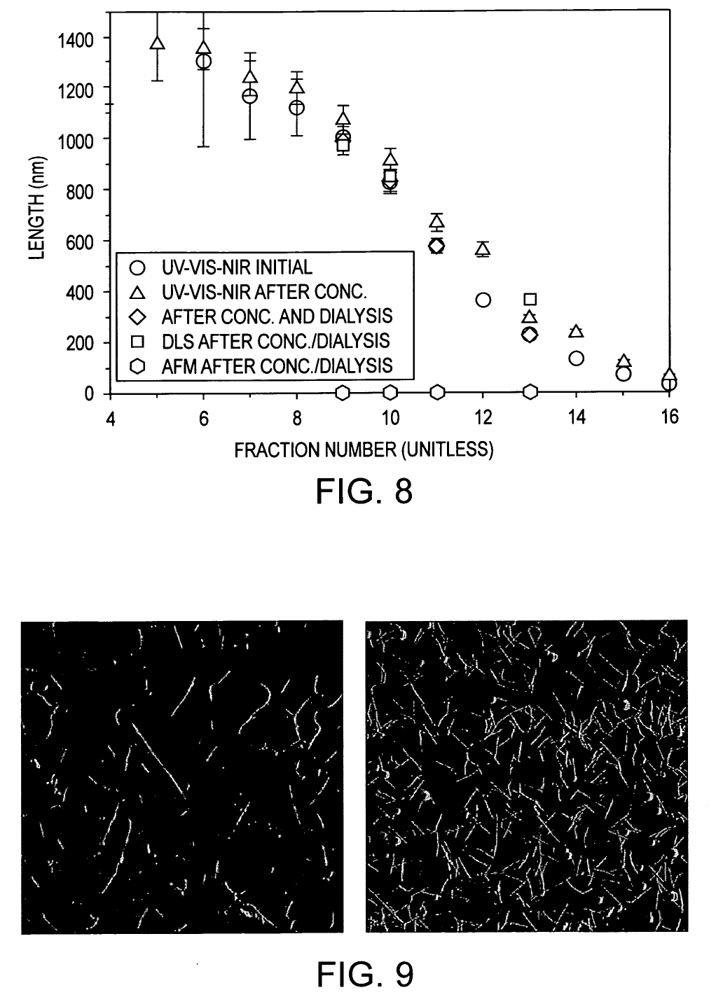

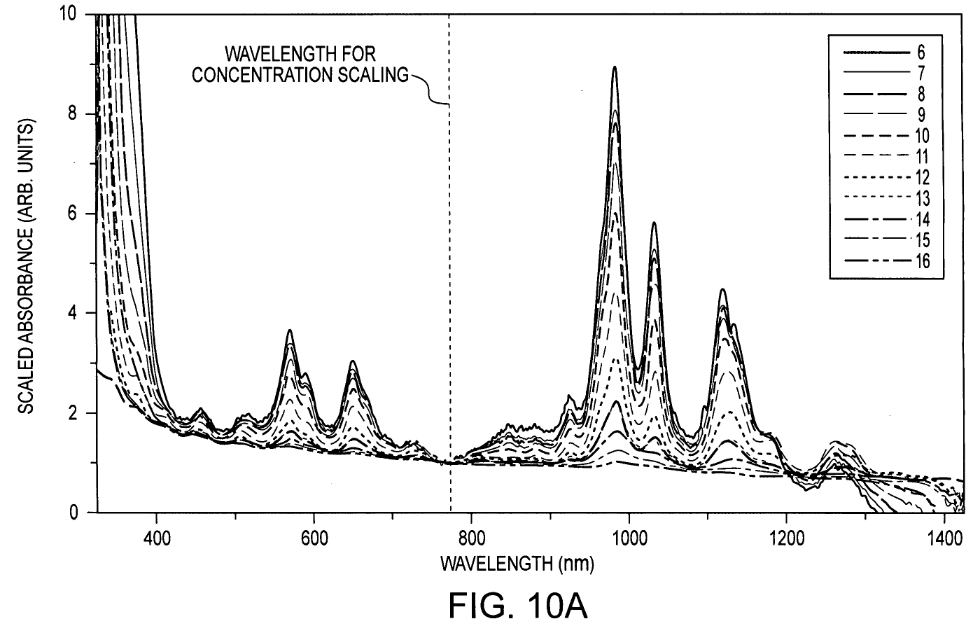

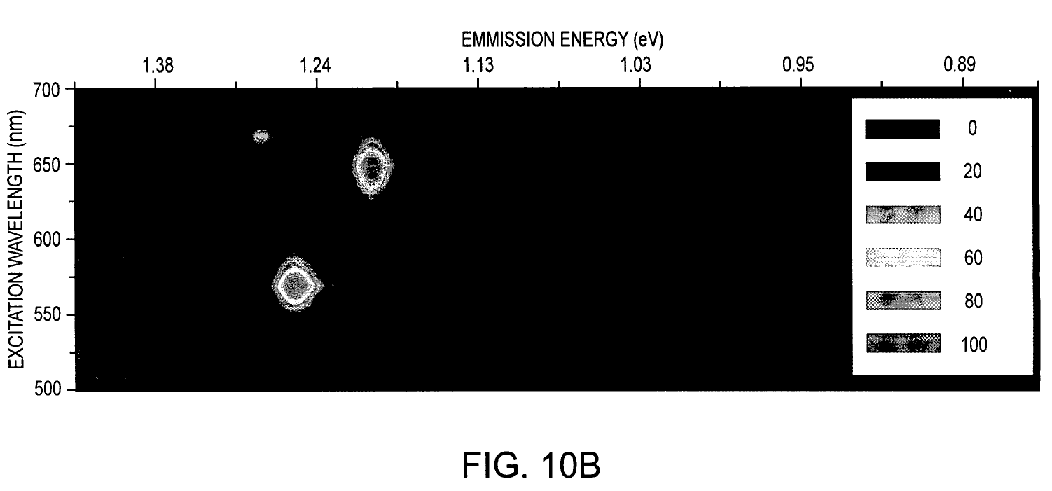

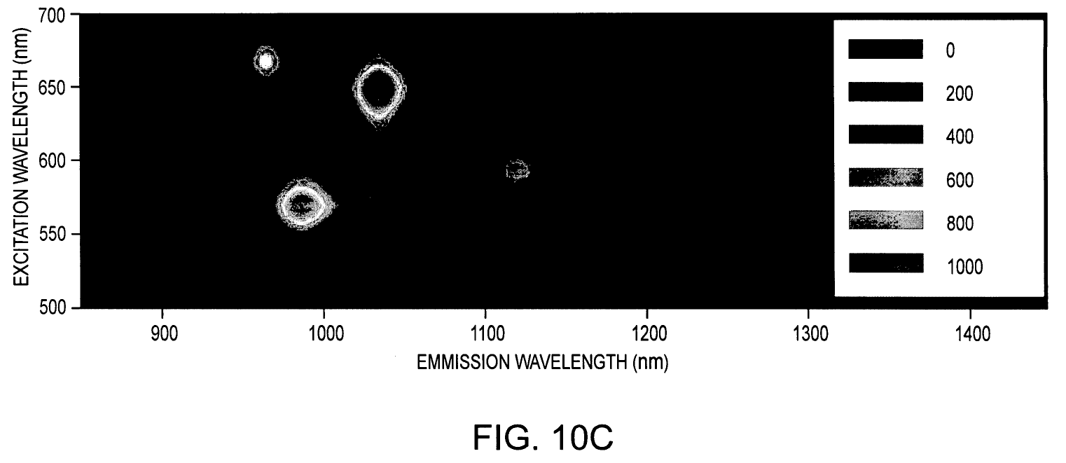

A schematic and photographs of aspects of preferred embodiment process are shown in FIG. 7. The band containing the SWCNTs is clearly visible. Measured lengths for the S-P95-02 CoMoCat SWCNTs shown in FIG. 7. And lengths from the collected fractions are presented in FIG. 8. Spectra, scaled for concentration at 775 nm are shown in FIG. 10A. When run to optimize the transient motion of the SWCNTs, high resolution of the separated lengths is achievable, and spectra showing well defined SWCNT peak features with increasing peak to baseline ratios are measured above the injection layer. SWCNT bundles, as determined by peak broadening, a red shift in peak location, and a decrease in peak absorption; remain in the injection layer and are typically not observed in centrifuged DOC solutions, but would be expected to fractionate downwards. High density impurities are seen to fractionate to the bottom of the tube and are not resuspended during fraction collection.

Specifically, FIG. 7 includes schematic illustrations and photographs of the length separation by centrifugation process for CoMoCat SWCNTs at 1257 Rad/s in DOC/iodixanol solution at 15° C. Longer nanotubes move farther in response to the applied centrifugation, and thus separate up the tube.

As previously described, the strength of the optical transition peaks can also be used to calculate the (length weighted) average length of the separated fractions. In particular, the relationship between the peak to baseline ratio and length is known for the specific batch of S-P95-02 grade CoMoCat fractions used in this contribution from previous size exclusion chromatography separations. This relation is defined in previously noted equation (6):

$$( nm ) \approx ( \frac{Absorbance ( 984 nm )}{Absorbance ( 775 nm )} - 0.842 ) * 160.4 nm \qquad ( 6 )$$

The values of the length from DLS, UV-Vis-NIR, and AFM for the fractions generated by centrifugation at 1257 Rad/s, shown in FIG. 7 are shown in FIG. 8. AFM images of selected fractions are presented in FIG. 9. The projected lengths of a given fraction tend to decrease with additional processing, such as with the concentration of like fractions or dialysis to remove the dense media, after the initial separation, despite most fractions being concentrated enough such that subtraction errors in the UV-Vis spectrum should be negligible. This is discussed in greater detail herein.

The length of the separated fractions was also determined using DLS, in VH scattering mode, from the extrapolated intercept at zero scattering vector for the inverse rotational relaxation time, which is equal to six times the rotational diffusion coefficient:

$${D}_{r} = 3 {k}_{B} T ( \frac{ln ( / 2 r ) - 0.8}{πη {3}^{}} ) . \qquad ( 7 )$$

The measured scattering for the fractions shown in FIG. 7 were plotted. The DLS experiment was repeated at a reduced, e.g. approximately one-third SWCNT concentration to look for any SWCNT concentration effects. The SWCNTs were found to behave similarly at the reduced concentration, indicating that the SWCNT concentration is not strongly affecting the effective size of the SWCNTs in the dispersion.

Specifically, referring to FIG. 8, values are shown for the UV-Vis-NIR projected length for the initial fractions as extracted from the tube and after centrifugal concentration, and then dialysis to remove the iodixanol, and as measured by AFM and DLS for fractions separated at 1257 Rad/s. Concentration and dialysis, necessary for DLS and AFM, both appear to modify slightly the average length of the SWCNTs remaining in solution. However, for UV-Vis-NIR projected average length values measured after these processes, the agreement with the AFM and DLS values is excellent. Error bars (1 standard deviation) are based on the instrument error and a 5% error in the slope of equation (7) for the UV-Vis-NIR projections; error bars for AFM were calculated from the counted SWCNTs.

AFM values are based on contour lengths measured for approximately 150 SWCNTs for each fraction. Images of several of the 1257 rad/s separated SWCNT fractions shown in FIG. 8 are presented in FIG. 9. The typical variance in the average length is approximately 20% for each of the measured fractions. The values measured using AFM show reasonable agreement to the values obtained via Equation (6) and from DLS. The differences may be explained by systematic difficulties in under-counting longer SWCNTs in AFM, as they tend to overlap other SWCNTs, and the length weighting of the UV-Vis-NIR and DLS techniques. Specifically, the difficulty in depositing individualized SWCNTs for imaging in AFM may affect the observed average length if there is preferentially attachment or rearrangement on the surface with length, and from the increased likelihood that longer SWCNTs will overlap other SWCNTs in an image and thus not be counted. Specifically, as shown in FIG. 9, AFM images on mica of selected length separated SWCNT fractions are presented from the separation depicted in FIG. 7. These fractions were concentrated, and then dialyzed to remove the remaining iodixanol polymer and excess surfactant prior to deposition for imaging.

The change in the strength of the optical transitions, but not in the type distribution of the SWCNTs is observable both in the UV-Vis-NIR absorbance spectra, and in the NIR fluorescence of the SWCNTs. Absorbance spectra, scaled by the value of the background subtracted absorbance at 775 nm, is plotted in FIG. 10A for the S-P95-02 grade CoMoCats shown in FIG. 7; the NIR fluorescence from E₂₂ excitation of the unsorted CoMoCat SWCNTs, and fraction 6 of the separated material are shown in FIGS. 10B and 10C respectively. In both FIGS. 10B and 10C, it is clear that the relative distribution of the peaks changes insignificantly, despite the large increase in the intensity of the features in the longer fractions.

Specifically, in FIG. 10A, scaled absorbance spectra of the length sorted nanotube fractions shown in FIGS. 7 and 8 is shown. Below 400 nm and above 1200 nm the curves are affected by the absorption of the density medium. The strength of the intrinsic SWCNT optical features increases strongly with the SWCNT length, whereas the relative sizes of the features to each other do not change significantly across the fractions. These results indicate length separation without chirality separation. The absorption spectra for the SWCNT mixture prior to separation (dashed spectra) is also shown. In FIGS. 10B and 10C, NIR fluorescence contour plots are shown for the very dilute dispersions of unsorted SWCNTs (FIG. 10B), and fraction 6 from the 1257 Rad/s separation shown in FIGS. 7. The scale bars in FIGS. 10B and 10C indicate the real intensity increase in the fluorescence with the length separation. The relative sizes of the feature being unchanged indicates that no preferential type separation is occurring.

Given the high resolution of the SWCNT fractions generated by the 1257 Rad/s separation, as demonstrated in the previous figures, significant additional characterization of those fractions was performed. Dialysis of the separated fractions to remove the iodixanol allows for resonant Raman interrogation of the fractions without the presence of the richly featured iodixanol Raman scatter.

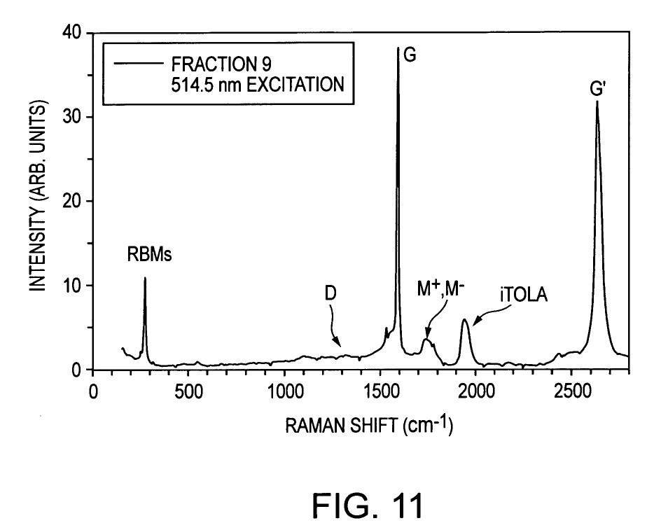

FIG. 11 illustrates Raman scattering from fraction 9, after dialysis to remove the iodixanol, of the 1257 Rad/s sorted CoMoCat fractions presented in FIGS. 7-12. The excitation wavelength was 514.5 nm. Strong features due to the RBMs, G, G′, iTOLA, M⁺, and M⁻ bands are clearly visible. The D band is measurable at 1328 cm⁻¹, but is insignificant on the scale of the figure. The G/D band ratio is approximately 250:1 for fraction 9. Due to partial excitation of the metallic-type SWCNTs in the CoMoCat sample, some Breit-Wigner-Fano broadening of the G band is observed. The noise is less than the line thickness. A small background contribution, which did not affect the relative feature size, was subtracted.

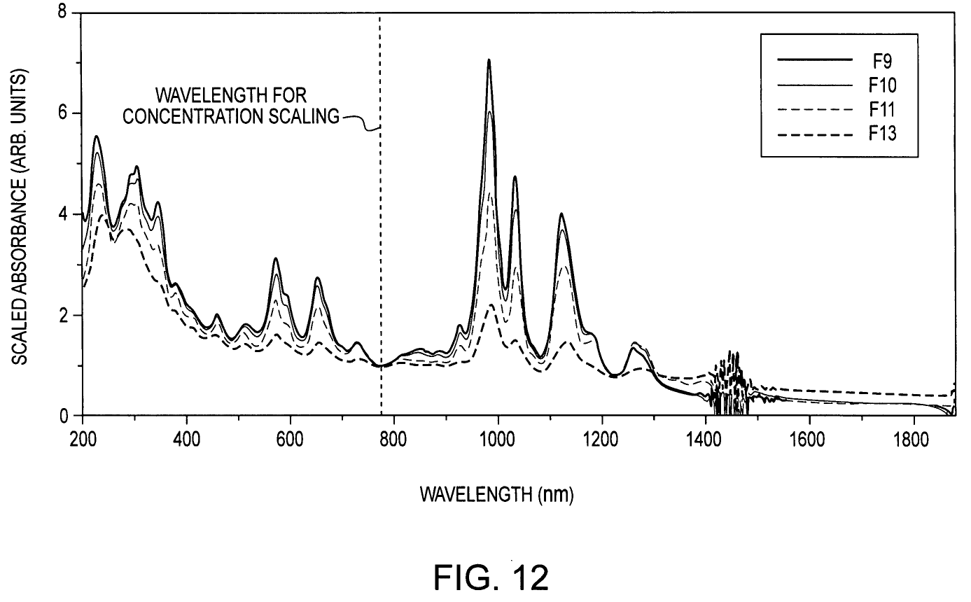

Dialysis of the separated fractions also allows for the interrogation of the absorbance in the UV spectrum. In FIG. 12, the absorbance features attributable to the E₃₃ excitation clearly become stronger and more distinct, as well as the E₁₁ and E₂₂ features, with the increase in the SWCNT length. The longer fractions are distinctly colored due to the large E₂₂ features relative to the baseline absorbance in the visible region.

Specifically, FIG. 12 illustrates scaled absorbance spectra of length sorted fractions 9, 10, 11 and 13 after concentration and dialysis to remove the iodixanol density media. The SWCNT optical transitions are clearly increased by the length separation, whereas the π-plasmon type absorption is much less sensitive to the SWCNT length. E₁₁, E₂₂, E₃₃ and overlapped E₄₄ optical transitions are observed.

As in FIG. 10A, it can be seen in FIG. 12 that the relative distribution of chiralities in the sample is not significantly altered by the length separation process. Chirality separation would appear as a dramatic shift in the relative size of the different transitions, shifting the relative sizes of the peaks roughly the same amount for each of the E₁₁, E₂₂, and E₃₃ transitions. However, further processing to produce such chirality enriched samples is possible using either the isopycnic method or rate based techniques.

Alternate scaling of the spectra in FIG. 12 for carbon concentration, either by πr-plasmon region absorbance or by the absorbance in the (1600 to 1800) nm region, does not significantly change the relative increase in the size of the absorption features with length. However, the exact shape of the absorbance below 220 nm as shown may be affected by slight differences in the DOC content of the samples, which is strongly absorbing in this region, with respect to the reference solution. The noise around 1450 nm in the spectra is due to inaccuracy in the subtraction of the strongly absorbing water feature at this wavelength.

Coupled with the independent measurement of the SWCNT lengths in the various fractions by AFM and DLS, as detailed in FIG. 8, FIG. 12 strongly demonstrates the length dependent strength of the SWCNT optical transitions that were previously noted in DNA-wrapped SEC sorted SWCNTs.

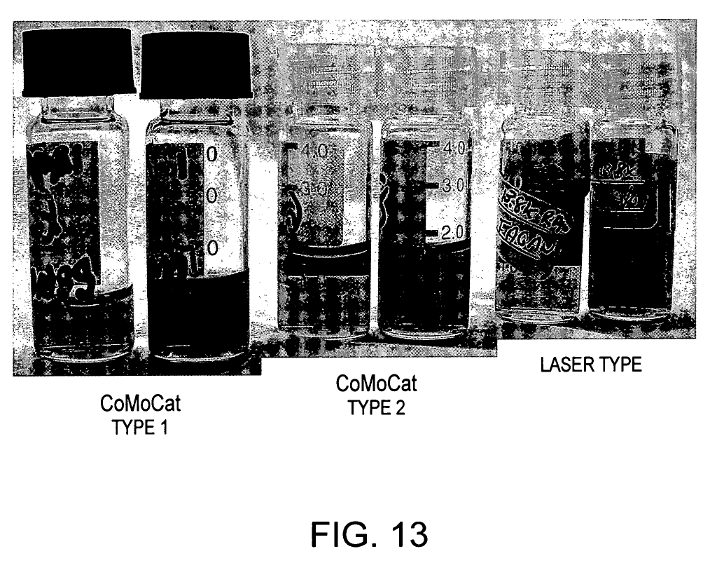

FIG. 13 is a photograph of several fractions from different parent solutions showing the solutions that result from the length separations. The solutions labeled CoMoCat type 1 are fractions 6 and 8 from the S-P95-02 grade CoMoCat material separated at 1257 Rad/s previously described. Specifically, FIG. 13 is a photograph of the different color SWCNT solutions that result from length separation of different type distributions of SWCNT starting material. Fractions 6 and 8 are shown for 1257 Rad/s separation of CoMoCat starting materials S-P95-02 and SG-000-0002 (left and center respectively), and fractions 9 and 10 for 1445 Rad/s separation of NASA-JSC soot #338 laser ablation type SWCNTs. Note that solely length and not chirality separation of the black parent solutions has occurred.

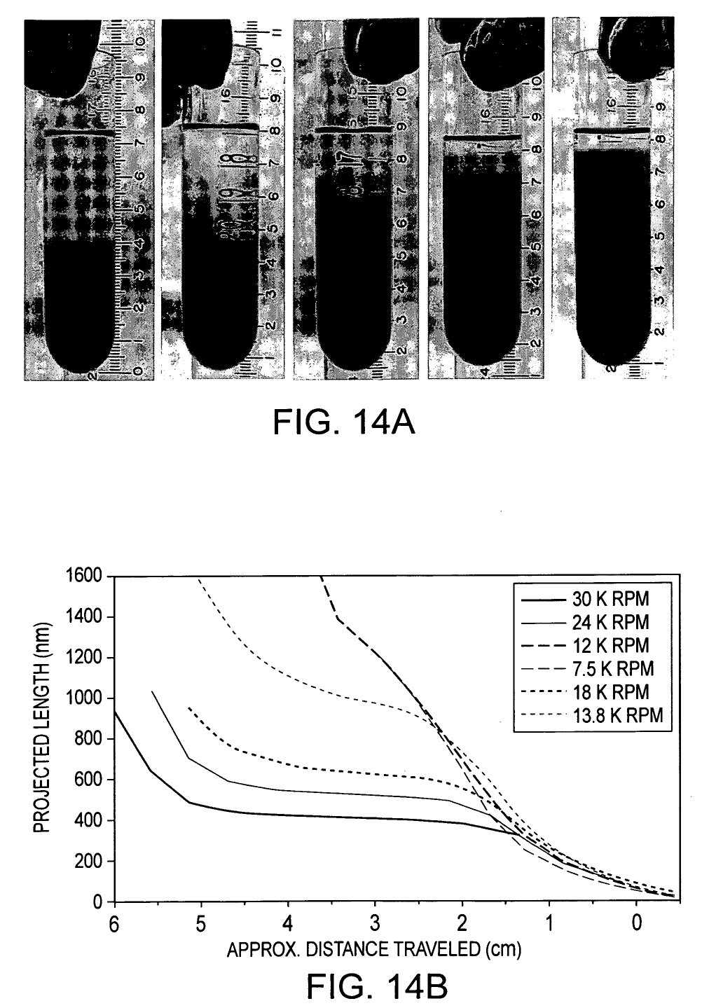

As demonstrated previously, and in the results shown above, SWCNTs can be separated by length through centrifugation in a dense medium. However, the degree and precision of the separation depend upon the chosen parameters for the separation. Several experimental variables are easily modifiable: separation rate, SWCNT concentration, the race layer density, and the bulk temperature of the solution. An increase in the rate of separation, i.e. an increase in the rotor RPM, but maintaining the total applied force generates surprising differences in the achieved separation. FIG. 14A contains photographs (left to right) of the separation at 785, 1257, 1570, 2513, and 3142 Rad/s, respectively, while FIG. 14B displays the UV-Vis-NIR projected lengths for the separated fractions. To probe the cause of the change in the separation with rotation speed, several additional investigations were performed at 3142 Rad/s. These included a preparation with approximately 20 mM of additional NaCl in each layer, and preparations with less surfactant (1%) in the layers. No significant change in the 3142 Rad/s separation was identified in either of these investigations.

Specifically, FIG. 14A presents photographs, left to right, of SWCNTs separated at 785, 1257, 1570, 2513, and 3142 Rad/s. Note that the furthest distance traveled by the SWCNTs increases with the separation rate, although the total applied force is constant across the experiments. The distribution of the separated SWCNTs within the race layer is also seen to change with the separation rate. Note that the aspect ratio of the images has been uniformly increased slightly to fit the images into the figure. FIG. 14B presents UV-Vis-NIR projected lengths for the fractions from the different rates of separation. Although the SWCNTs travel the least in the fractions of 785 and 1257 Rad/s, the separation achieved is closest to the theoretical expectation. The plateau region that develops at higher rates of separation is due to mixing of different length SWCNTs.

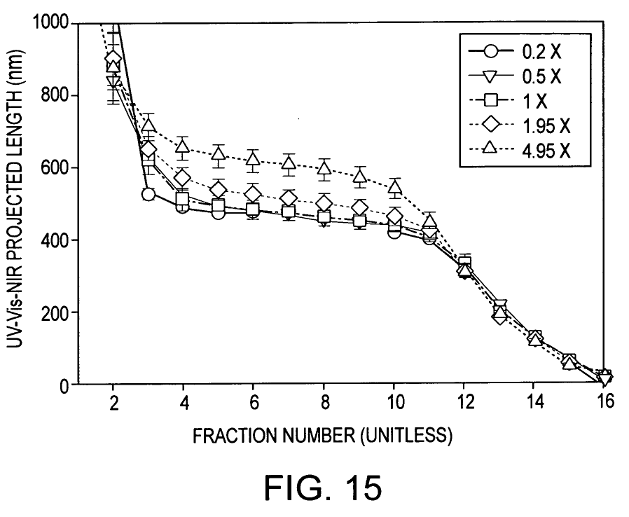

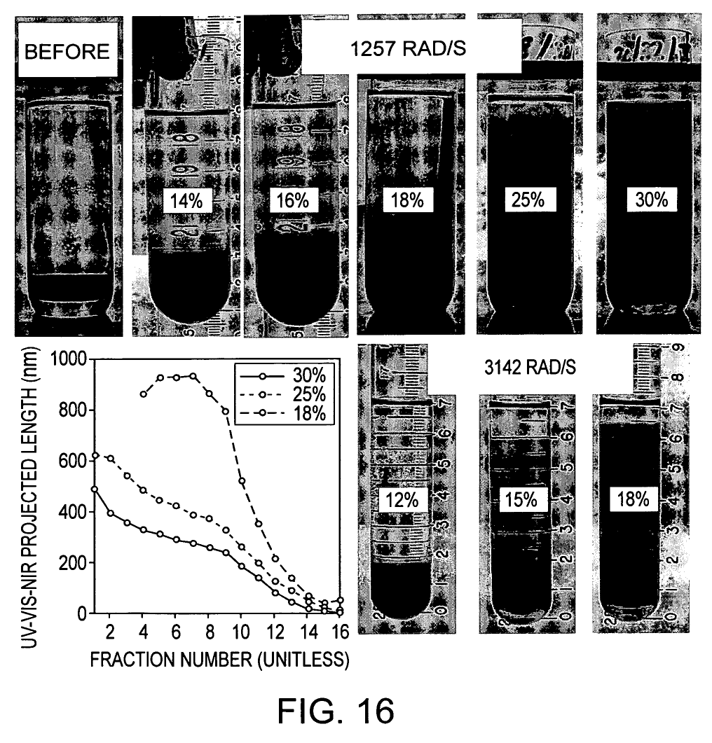

Although each of the experiments shown in FIGS. 14 and 16 contained an identical concentration of SWCNTs within the injection layer, for scaling up the separation process, the exact effects of SWCNT concentration on the measured separation could be highly important. Thus, separation experiments were performed with fractional SWCNT concentrations of 4.95×, 1.95×½, and ⅕^{th} the typical inoculation. In absolute terms 1× is a concentration of about 0.24 mg/mL within the SWCNT layer in the centrifuge tube, as determined using an estimated extinction coefficient at 775 nm of 26000 mL/mg*cm. The results of the separation, performed at 3142 rad/s for 15 h at 15° C., are shown in FIG. 15. Surprisingly, the average length of the SWCNTs within the plateau feature increases with additional SWCNT inoculation concentration, actually improving the effected separation. No significant change is observed in the post-separation distribution of lengths with reduction in the initial concentration. A shift towards improved separation is noted with an increase in SWCNT concentration, i.e. for higher mass throughout.

Specifically, FIG. 15 illustrates the effects of concentration. Changes in the achieved separation were found, however, to occur with an increase in the density of the liquid layers in the centrifuge tube. This is shown in FIG. 16, in which three tubes are shown where the race layers contained 18, 25, and 30% iodixanol respectively, and the separation was performed at 1257 Rad/s as in the investigation presented in FIGS. 7 and 8. Interestingly, the changes in the separation with the race layer density mimic the changes that occur due to an increased rotor speed, with the same turnover and plateau features observed in the apparent average length versus distance curves. Reducing the race layer density also changes the separation. This is shown for separation at 3142 Rad/s in FIG. 16. The reduction in layer density from 18% to 15% actually improves the separation, as can be seen in the projected length. However, with a top layer of 12% iodixanol, separation occurs due to both length and chirality, and the length cannot be projected due to this chirality redistribution. The top fraction of the concentrated band was found to be heavily enriched in the lower density (6,5) chirality.

Specifically, FIG. 16 presents photographs and apparent SWCNT length versus distance traveled curves for the separation of CoMoCat SWCNTs at 1257 Rad/s (top) and at 3142 Rad/s (bottom) using different density race layers. As expected, at 1257 Rad/s the distance traveled increases with the density of the race layer. However, the separation also becomes less ideal, similar to the effect measured due to an increase in the applied centripetal acceleration. For separation at 3142 Rad/s the separation is more ideal at 15% than at 18%, however, at 12% iodixanol in the race layer, a mixture of chirality and length separation occurs.

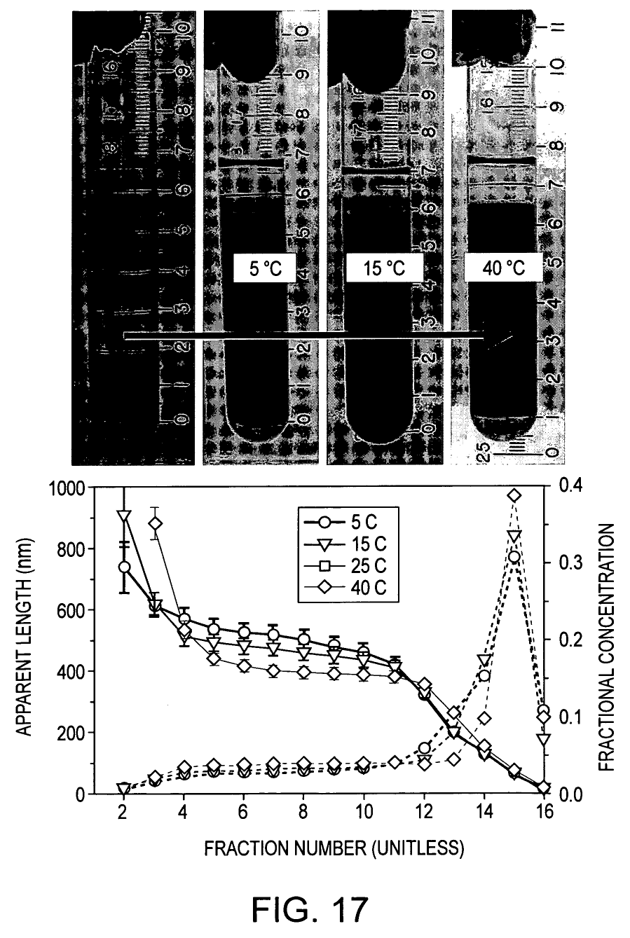

The effect of the bulk temperature during the separation was also explored. Runs at 5° C. and 15° C. were equilibrated to temperature prior to the run within the ultracentrifuge. For the 40° C. separation, the rotor, buckets, and solutions were equilibrated to the proper temperature by immersion in a thermostated bath for several hours prior to introduction to the centrifuge chamber. The effects of the temperature on the separation are shown in FIG. 17. Surprisingly, the reduction in temperature, even from 15° C. to 5° C., causes a significant redistribution of the SWCNT concentration in the solution. This redistribution generally improves the separation as discussed below.

Specifically, FIG. 17 presents photographs and apparent SWCNT length versus distance traveled curves showing the effect of temperature on the measured length separation performed at 3142 Rad/s. Performing the separation at lower temperatures improves the resolution of the fractions, as indicated by the increased slope of the apparent length values. The dashed curves display the fractional concentration, as measured by absorbance at 775 nm, for the displayed separations. The integrated concentration is the same in each experiment.

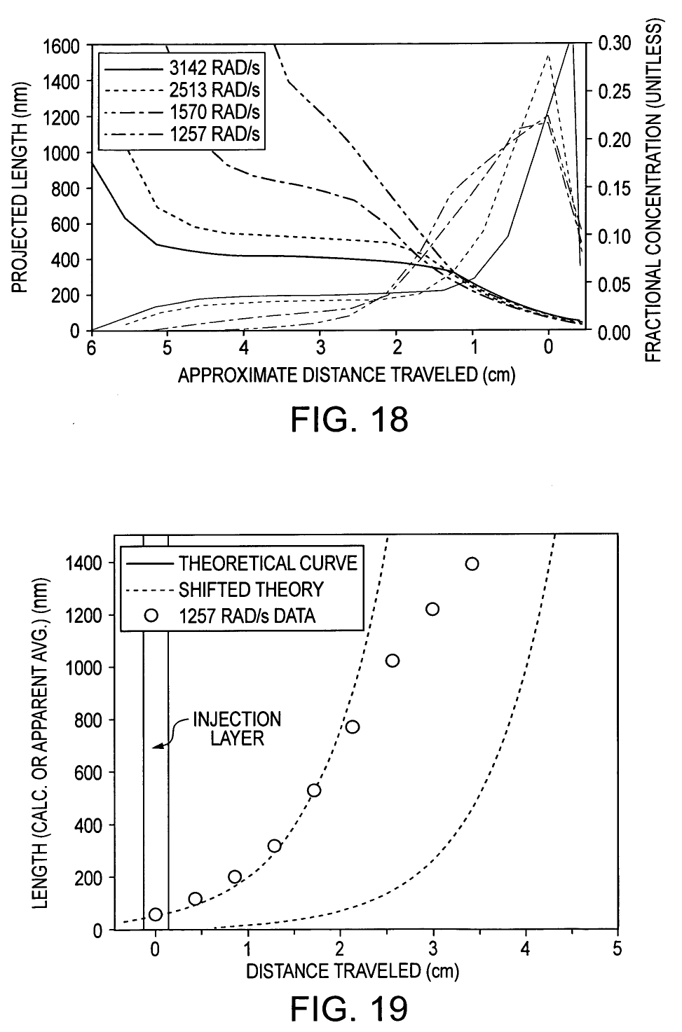

Plotting the fractional concentration profile versus fraction number for four of the different separation speeds shown in FIG. 14 in FIG. 18, it can be inferred that the plateau feature observed at higher separation rates is due to a mixture of different lengths in those fractions, and not due to a different spatial distribution of well resolved lengths. This is visible in the dramatic reduction in the concentration of the short SWCNTs in the fraction approximately 0.5 cm from the injection layer with the increase in the separation rate from 1257 Rad/s to 3142 Rad/s. The plateau feature in the higher rate separations is the result of this short material being mixed upwards in the liquid column, and reducing the average length of those fractions. 1257 Rad/s generated the steepest projected length curve under these conditions. Including the information of the relative concentration for each average length it is clear that this separation resulted in the greatest resolution of length in the different fractions. Integrating each of the concentration and length curves to calculate an average length value for the separated SWCNTs yields a value of 225±5 nm in each case, equal to the average length projected by UV-Vis-NIR absorbance for the unsorted material of approximately 220 nm.

Specifically, FIG. 18 illustrates concentration profiles (thin lines) from the absorbance at 775 nm versus the distance traveled for selected separations shown in FIG. 13, and the UV-Vis-NIR projected length values (bold lines) from the same separations. The slower separations yield fractions of smaller width as evidenced by the change in the concentration curves while remembering that the injected dispersion was identical in all four experiments. Integration of the curves to calculate the initial average length yields a common value 225±5 nm for all of the curves.

A comparison of the measured average length versus distance traveled curves from the 1257 Rad/s separation to the simple theory in equation (4) is shown in FIG. 17. The expected functionality given by equation (4) is seen in the more resolved 1257 Rad/s separation, although the theoretical curve is shifted in position toward further traveled distance. The most likely cause for this disagreement is the downward motion of the iodixanol polymer in response to the applied centripetal acceleration. This motion has been modeled using the Lamm equation by both Arnold et al and Nitish et al. in predicting the final position of SWCNTs during isopycnic (chirality) separation using ultracentrifugation. In both literature results, the redistribution of the iodixanol is significant with centrifugation. Due to the strong absorption of the iodixanol, it was determined that the uppermost two to four fractions are significantly depleted (up to 70% for the top fraction), and the bottommost fractions, numbers 14, 15 and 16, increase significantly in iodixanol concentration, during centrifugation. This demonstrated redistribution, would affect the translation of the SWCNTs in the same manner that a body traveling against a moving flow is affected; an outside observer measures significantly less motion in the static reference frame than is experienced by the traveling body. Empirically shifting the theoretical curve demonstrates that the shape of the measured average length values is consistent with the theory.

Specifically, FIG. 19 compares the measured average length in each fraction for the 1257 Rad/s separation shown in FIGS. 7 and 8 with the theoretical prediction of equation (4). Assuming only equation (4), the theory qualitatively predicts the shape of the separation, but does not quantitatively predict the actual positions of the separated SWCNTs in the experiment. However, equation (4) assumes that the reference frame for the motion of the SWCNTs is the centrifuge tube. A more accurate description of the physics must include that the density medium is also pelleting during centrifugation. Downward drag from the pelleting iodixanol would, to first order, shift the separation curve to less distance traveled. A uniformly shifted curve matches the experimental data for a SWCNT-surfactant shell diameter of approximately 7.5 nm. There are two sets of possible explanations for the observed behavior of the SWCNTs with the separation rate: theories based on SWCNT initiated effects, and theories based on environment initiated effects. Examples of environment initiated effects would include generation of a sedimentation potential due to the centrifugation rate dependent rearrangement of the surfactant and iodixanol molecules, driven changes in the surfactant micelle structure due to the intensity of the induced pressure gradient, or generation of convection due to vibrations. SWCNT initiated effects could include concentration dependent association or aggregation, or alignment effects due to the gradient in centrifugal acceleration. The experiments detailed above allow the elimination of some of these possibilities. Given the noted results, it appears unlikely that external influences from the centrifuge are the cause of the mixing phenomenon. Identical separation at 3142 Rad/s is observed using either the ⅝ inch or 1 inch diameter centrifuge tubes indicates that vibrations or large flows are not likely causes of the observed behavior. Furthermore, the induction of an apparently similar mixing effect to that observed with an increase in separation rate by increasing the density of the layers at 1257 Rad/s implicates that the effect is intrinsic to separation parameters and is not externally generated. Likewise, the lack of change with the addition of 20 mM NaCl indicates that charge effects are unlikely to be the cause of the mixing behavior.

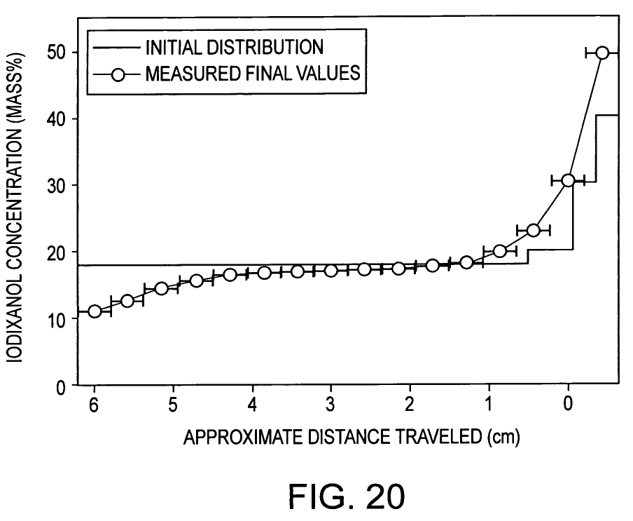

FIG. 20 illustrates redistribution of iodixanol during centrifugation. Bars on the points represent the width of the measured fractions within the centrifuge tube. The upper fractions lose significant amounts of iodixanol due to its downward sedimentation. However, the large size of the race layer allows the initial density to be approximately maintained for several cm above the SWCNT injection layer. This measurement was performed on a sample containing no SWCNTs in the injection layer, but that was otherwise identical in preparation. Additional drag on the oppositely traveling SWCNTs is expected due to this sedimentation.

The economic value of the preferred embodiment centrifugation process is significant. An estimate for the cost per mg of the separation process for the centrifugation techniques on the demonstrated bench-top scale is, for a 1257 Rad/s, 96 h separation, assuming no recovery of the density medium, approximately $7.50 per mg of SWCNTs separated. The cost is primarily associated with the differential rotor cost of approximately $17,000/100 separations per rotor, which is approximately $17 per separation; and for the density gradient medium, approximately $23.50 per separation, generating 6 to 10 mg of separated SWCNTs. The SWCNT cost approximately $1/mg after dispersion and centrifugation to remove amorphous impurities, the cost of the surfactant approximately $1.50 per separation and the cost of electricity are relatively marginal factors. Recovery of the density medium, and shorter separations times dramatically reduce the projected marginal cost. For size exclusion chromatography in contrast, the current necessity of using custom made small number oligimer single-stranded DNA to achieve an acceptably robust dispersion introduces an approximate cost of $15 to $20 per mg of dispersed SWCNT, prior to even the length separation, solely due to the DNA.

Centrifugation can be used to separate single wall carbon nanotubes by length. Separation improves with a reduced rate of separation, however the exact cause of this improvement is unclear. Length for separated fractions measured using AFM, DLS, and UV-Vis-NIR extrapolation were found to be in consistent agreement. Longer SWCNTs are found to have stronger optical transitions consistent with previous results. These long SWCNT display excellent optical properties. Length separation by this method is relatively facile compared to previous techniques, and is estimated at bench scale to cost less than $4/mg of separated SWCNTs given (the facile) recovery of the density inducing polymer.

Many other benefits will no doubt become apparent from future application and development of this technology.

All patents, published patent applications, and articles referred to herein are hereby incorporated by reference in their entirety.

As described hereinabove, the present invention solves many problems associated with previous type devices. However, it will be appreciated that various changes in the details, materials and arrangements of parts, which have been herein described and illustrated in order to explain the nature of the invention, may be made by those skilled in the art without departing from the principle and scope of the invention, as expressed in the appended claims.

What is claimed is:

1. A method for separating carbon nanotubes by length, the method comprising:
providing carbon nanotubes having different lengths;
dispersing the carbon nanotubes in a suitable medium to solubilize the nanotubes and thereby form a first liquid;
preparing a second liquid having an appropriate density with respect to the solubilized nanotubes;
forming an array of liquid layers in a vessel including a first layer comprising the first liquid and a second layer disposed above the first layer, the second layer comprising the second liquid;
centrifuging the vessel and array of layers for a time period sufficient for at least a portion of the nanotubes in the first layer to migrate into the second layer and form a plurality of fractions in the second layer, wherein each fraction includes carbon nanotubes having an average length different than that of other fractions in the vessel.

2. The method of claim 1, wherein the first liquid comprises water.

3. The method of claim 2, wherein the first liquid further comprises surfactant.

4. The method of claim 1, wherein dispersing includes an operation selected from the group consisting of (i) sonicating the medium and the carbon nanotubes, (ii) centrifuging the medium and the carbon nanotubes, and (iii) combinations of (i) and (ii).

5. The method of claim 1, wherein the second layer comprises a density adjusting agent.

6. The method of claim 5, wherein the density adjusting agent is 5,5′-[(2-hydroxy-1-3 propanediyl)-bis(acetylamino)]bis [N,N′-bis(2,3dihydroxylpropyl-2,4,6-triiodo-1,3-benzenecarboxamide]

7. The method of claim 5, wherein the second layer further comprises a surfactant.

8. The method of claim 1 wherein the array of liquid layers further includes a third layer disposed below the first layer, the third layer having a density greater than that of the first layer.

9. A method for separating carbon nanotubes by length, the method comprising:
obtaining carbon nanotubes having a range of different lengths;
dispersing the carbon nanotubes in a first liquid to thereby form a dispersed sample of carbon nanotubes;
selecting a second liquid having a density such that the difference between (i) the density of the second liquid and (ii) the average density of the carbon nanotubes in the dispersed sample, is greater than the difference between (ii) and (iii) the density of any species of carbon nanotubes in the dispersed sample;
in a vessel adapted for centrifugation, forming a first layer comprising at least a portion of the dispersed sample and forming a second layer comprising at least a portion of the second liquid, wherein the second layer is disposed above the first layer;
centrifuging the vessel and first and second layers for a time period sufficient for a plurality of fractions to form within the second layer, wherein each fraction includes carbon nanotubes having an average length different than that of other fractions in the vessel.

10. The method of claim 9, wherein the first liquid comprises water.

11. The method of claim 10, wherein the first liquid further comprises surfactant.

12. The method of claim 9, wherein dispersing includes an operation selected from the group consisting of (i) sonicating the first liquid and the carbon nanotubes, (ii) centrifuging the first liquid and the carbon nanotubes, and (iii) combinations of (i) and (ii).

13. The method of claim 9, wherein the second liquid comprises 5,5′-[(2-hydroxy-1-3 propanediyl)-bis(acetylamino)]bis [N,N′-bis(2,3dihydroxylpropyl-2,4,6-triiodo-1,3-benzenecarboxamide].

14. The method of claim 9, wherein the second liquid comprises surfactant.

15. A method for separating carbon nanotubes by length, the method comprising:
providing carbon nanotubes having different lengths;
dispersing the carbon nanotubes in water to form an aqueous mixture of the nanotubes and water;
forming a liquid having a density such that the difference between (i) the density of the liquid and (ii) the average density of the carbon nanotubes in the aqueous mixture, is greater than the difference between (ii) and (iii) the density of any species of carbon nanotubes in the aqueous mixture;
forming an array of layers in a vessel including a first layer comprising at least a portion of the aqueous mixture, a second layer disposed above the first layer, the second layer comprising at least a portion of the liquid and having a density less than that of the first layer, and a third layer disposed below the first layer, the third layer having a density greater than that of the first layer;
centrifuging the vessel and first, second, and third layers for a time period sufficient for a plurality of fractions to form within the second layer, wherein each fraction includes carbon nanotubes having an average length different than that of other fractions in the vessel.

16. The method of claim 15, wherein at least one of the first layer, the second layer, and the third layer comprises surfactant.

17. The method of claim 15, wherein the liquid in the second layer comprises 5,5′-[(2-hydroxy-1-3 propanediyl)-bis(acetylamino)]bis [N,N′-bis(2,3dihydroxylpropyl-2,4,6-triiodo-1,3-benzenecarboxamide].

18. The method of claim 15, wherein the third layer comprises 5,5′-[(2-hydroxy-1-3 propanediyl)-bis(acetylamino)]bis [N,N′-bis(2,3dihydroxylpropyl-2,4,6-triiodo-1,3-benzenecarboxamide].

19. The method of claim 15, wherein the first layer comprises 5,5′-[(2-hydroxy-1-3 propanediyl)-bis(acetylamino)]bis [N,N′-bis(2,3dihydroxylpropyl-2,4,6-triiodo-1,3-benzenecarboxamide].

20. The method of claim 15, wherein the average length of carbon nanotubes in a fraction proximate to a location of the first layer is less than the average length of carbon nanotubes in a fraction farther from the location of the first layer.
